(19) United States
(12) Patent Application Publication
(10) Pub. No.: US 2018/0249756 A9
(43) Pub. Date: Sep. 6, 2018

(54) Free-Flowing Edible Composition, a Foodstuff Comprising It, Methods Employing It and a Method of Making the Composition

(71) Applicant: Tate & Lyle Ingredients Americas LLC, Hoffman Estates, IL (US)

(72) Inventors: Shiji Shen, Algonquin, IL (US); Susan E. Butler, Crystal Lake, IL (US); Andrew J. Hoffman, West Point, IN (US); Justin Kanthak, Bartlett, IL (US); John Bridges, Algonquin, IL (US)

(21) Appl. No.: 15/552,769

(22) PCT Filed: Feb. 16, 2016
(86) PCT No.: PCT/GB2016/050373

§ 371 Date: Aug. 22, 2017

Related U.S. Application Data
(60) Provisional application No. 62/120,775, filed on Feb. 25, 2015.

(51) Int. Cl. A23P 10/40; A23P 20/10; A23L 27/16; A23L 27/30; A23L 27/40

(52) U.S. Cl. CPC A23P 10/40; A23V 2250/638; A23L 27/16; A23L 27/33; A23L 27/40; A23V 2002/00; A23V 2200/044; A23V 2200/10; A23V 2200/15; A23V 2200/16; A23V 2300/24; A23V 2250/212; A23V 2250/5114; A23V 2250/606; A23V 2250/608; A23V 2250/612; A23V 2250/61; A23V 2250/616; A23V 2250/628; A23P 20/105

(57) ABSTRACT

The present disclosure relates to a free-flowing composition having controllable properties of bulk density, particle morphology, flowability and shakeability suitable, for example, for use on or in a foodstuff or a beverage. The composition includes a blend of: (i) a plurality of substantially discrete composite particles, each composite particle comprising a core of a first edible material provided with a discontinuous surface coating formed from a first plurality of non-uniformly sized particles of a second edible material; and (ii) a second plurality of non-uniformly sized particles of said second edible material. A foodstuff comprising the composition is claimed and so are methods of employing it. The application also claims a method of preparing thee composition, said method comprising the steps of: (a) combining the first edible material, provided in dry particulate form, with the second edible material, provided in dry particulate form; and (b) heating said combination to a forming temperature (T_{f}), which is at least equal to the glass transition temperature or softening temperature of the first edible material, with concurrent mixing thereof, so as to coat particles of the first edible material with a first plurality of non-uniformly sized particles of the second edible material, thereby forming composite particles of said composition, and leaving a second plurality of non-uniformly sized particles of the second edible material remaining which are intermingled with said composite particles.

### BACKGROUND OF THE DISCLOSURE

### 1. Field of the Disclosure

The present disclosure relates to a novel, free-flowing composition suitable, for example, for use on or in a foodstuff or a beverage.

### 2. Technical Background

Reduction in the amounts of certain food ingredients in our diets has been of increasing concern and importance over the last few decades, particularly in the amounts of flavourings such as salt (e.g., sodium chloride) and refined sugar (i.e., sucrose), for both health-related and cost reasons. Various methods have been proposed to effect such reductions, e.g. ingredient replacement, use of enhancing co-ingredients, use of sensory enhancers, with a view to at least maintaining the desired effect of the ingredient, e.g., taste improvement or enhancement.

Despite often positive benefits, unfortunately, however, the proposed methods and their products have also presented further problems to a greater or lesser extent, including the consumer experiencing an “off-taste” and/or an unpleasant or disagreeable “after-taste” from the product, increased cost due to the use of additional ingredients and/or processing steps, and difficulty in storing and handling the product.

Taking salt, being a ubiquitous food and beverage ingredient, as a particular example, it had been proposed to effect salt reduction by reducing the average particle size of the sodium chloride crystals. Ordinary table salt particles are typically in the range of from 200 μm to 700 μm, with kosher salt and sea salt often being provided with even larger particle sizes. Reducing the particle size to below 100 μm, for example, has been found to provide an intense salt taste, thought to be due to more rapid and complete solubilisation in a consumer's mouth of the reduced size particles as compared to the larger particles. However, the smaller salt particles are difficult to manufacture and stabilize, as they very rapidly agglomerate. And even table salt-sized particles can agglomerate in the absence of anti-caking agents due to almost instantaneous adsorption of moisture on account of the hygroscopicity of sodium chloride. Furthermore, the salty taste which, although may be initially intense and satisfying, often quickly disappears when the particle size is small.

In the art, it is also known to provide methods of production of small salt particles (i.e. less than approximately 100 μm) that are stabilized by prevention of particle agglomeration by forming the small salt crystals or particles on and/or within “carrier” granules or spheres of a larger size (i.e. greater than approximately 100 μm). Such methods make use of aqueous solutions (or solutions using other solvents) and a variety of drying methods to manufacture the particles.

Again, however, such “wet” methods of manufacture have significant limitations. In the case of spherical, hollow particles, it is difficult to prepare particles over 100 μm in size without also encountering a not-insignificant degree of particle breakage (leading to fragments). By way of example, in certain manufacturing methods working with particles having a low bulk density, especially below about 0.6 g/cm³, results in significant dusting problems during manufacturing and poor flow properties. In general, low bulk density products (<0.6 g/cm³) cannot be used as table top salt replacer product without addition of other materials, which is often poorly perceived by the consumer.

Furthermore, use of aqueous salt solutions in manufacture often leads to significant corrosion issues due to use of high chloride-content solutions, a problem exacerbated with expensive and often delicate equipment used for drying (e.g. spray-dryers and the like). Moreover, removal of large amounts of water from aqueous feeds is an inherently energy-intensive and expensive process, even if the long-term costs of corrosion are ignored.

And, again, the problem of an often rapidly disappearing initial salty taste remains.

It would therefore be desirable to at least mitigate the problem of a rapidly disappearing initial salty taste and indeed at the same time to address one or more of the other problems identified above with the production of reduced size salt particles, having an average size of less than 100 μm. It would be desirable to provide an edible composition having an improved taste temporal profile, which is widely applicable to other food and beverage ingredients with a view to an overall reduction in the amount consumed per unit measure, and which may be applied to senses other than simply taste, i.e. which enables control of other organoleptic properties.

### SUMMARY OF THE DISCLOSURE

One aspect of the disclosure is a free-flowing edible composition having controllable properties of bulk density, particle morphology, flowability and shakeability, said composition including a blend of:
(i) a plurality of substantially discrete composite particles, each composite particle comprising a core of a first edible material provided with a discontinuous surface coating formed from a first plurality of non-uniformly sized particles of a second edible material; and
(ii) a second plurality of non-uniformly sized particles of said second edible material.

Another aspect of the disclosure is a method for making a composition having controllable properties of bulk density, particle morphology, flowability and shakeability as described herein, the method including
(a) combining the first edible material, provided in dry particulate form, with the second edible material, provided in dry particulate form; and
(b) heating said combination to a forming temperature (T_{f}), which is at least equal to the glass transition temperature or softening temperature of the first edible material, with concurrent mixing thereof, so as to coat particles of the first edible material with a first plurality of non-uniformly sized particles of the second edible material, thereby forming composite particles of said composition, and leaving a second plurality of non-uniformly sized particles of the second edible material remaining which are intermingled with said composite particles.

Another aspect of the disclosure is the use of a composition as described herein as a delivery vehicle to provide an organoleptic property of the second edible material having a desired time profile.

### BRIEF DESCRIPTION OF THE DRAWINGS

FIG. 1 is a scanning electron micrograph (SEM) image of a plurality of composite particles forming part of a blend comprised in a free-flowing edible composition according to the first aspect of the disclosure;

FIG. 2 is an SEM image of a free-flowing edible composition CSB-2 according to the first aspect of the disclosure;

FIG. 3 is picture of a particulate salt sample of non-uniform particle size after two weeks storage in a sealed jar under ambient conditions;

FIG. 4 is a picture of the free-flowing edible composition CSB-2 after three months storage in a sealed jar under ambient conditions;

FIG. 5 is a graph of particle size distributions for the salt material of FIG. 3 and the free-flowing edible composition of FIG. 2;

FIG. 6 is a graph of particle size distributions for the CSB-1, CSB-2, Comp.1 and Comp. 2 samples used in sensory testing;

FIG. 7 is an SEM image of the CSB-1 composition used in sensory testing;

FIG. 8 is an SEM image of the Comp. 1 composition used in sensory testing;

FIG. 9 is an SEM is image of the Comp. 2 composition used in sensory testing; and

FIG. 10 is a graph of particle size distributions for the CSB-6, CSB-8 and CSB-9 samples used in shakeability testing.

### DETAILED DESCRIPTION

According to a first aspect of the disclosure, there is provided a free-flowing edible composition comprising a dry blend of:
(i) a plurality of substantially discrete composite particles, each composite particle comprising a core of a first edible material provided with a discontinuous surface coating formed from a first plurality of non-uniformly sized particles of a second edible material; and
(ii) a second plurality of non-uniformly sized particles of said second edible material.

The free-flowing edible compositions described herein, having controllable properties of bulk density, particle morphology (in relation to both the morphology of the composite particles and the morphology of the particles of second edible material), flowability and shakeability (which will be defined below), can provide many benefits and advantages over prior art compositions including or consisting of the second edible material, including, for example, non-dusting and non-aggregating properties and an improved character, such as an improved temporal profile of the taste (or another organoleptic property) of the second edible material. For example, salt particles with a broad size distribution tend to aggregate strongly; the inventors have determined that various compositions as described herein, despite including a second edible material of non-uniform particle size (and even with a relatively broad size distribution). Moreover, the inventors have determined that the compositions described herein can provide the second edible material with a strong and long-lasting taste profile, due, for example, to a longer-lasting dissolution profile for the second edible material. The numerous benefits and advantages achievable are a direct consequence of the ability to vary one or more of the controllable properties (of bulk density, particle morphology, flowability and shakeability) of the composition. Details of how to effect such variation(s) will be described in more detail below.

Provision of a blend of composite particles (comprising a quantity of particles of second edible material, which may be considered as being “bound” to the cores of the composite particles) along with a further quantity of particles of the second edible material (which may be considered as being “loose” and generally able to flow between and around the composite particles) means that particles of the second edible material are not able to pack together as closely as they would otherwise have been able to in their “pure” form, i.e. in the absence of the composite particles. Thus the bulk density of the composition of the disclosure can be reduced as compared to the bulk density of the “pure” form of the second edible material, leading to a reduced likelihood of aggregation and clumping.

The fact that the second edible material is provided in the form of pluralities of non-uniformly sized particles means that both comparatively larger and smaller sized particles are present in the composition overall, the smaller ones of which will release their character, e.g. their taste, on consumption more quickly than the larger of the particles, which will take a comparatively longer time to release their character as a result of their relatively smaller surface-to-volume ratio. Such a combination of faster and slower release together provide an extended, and thus improved, temporal profile.

Furthermore, in various particular embodiments, the particles of second edible material can also be of non-uniform shape (i.e., in addition to being non-uniformly sized).

The nature of the free-flowing compositions described herein is such that a high degree of characteristic control is available; i.e., in view of the description provided herein, it is possible for the person of ordinary skill in the art to control and manipulate aspects such as the microstructure of the composite particles in the blend, the overall particle sizes of the composite particles, the composition of both the composite particles and the blend overall, by appropriate selection and manipulation of the size of:
the core of the composite particles to affect the overall particle size of the composite particles
the ratio of first edible material to the first plurality of particles of second edible material to affect the overall content of the second edible material
the ratio of the composite particles to the second plurality of particles of second edible material, again to affect the overall content of the second edible material
the particle sizes and their distribution in each of the first and second pluralities of non-uniformly sized particles of second edible material to affect the character (e.g. taste) release properties thereof
the nature, i.e. type, of material(s) used as the first and second edible materials.
   Manipulation of such properties can allow the person or ordinary skill in the art to provide a composition with a desired taste profile (i.e., owing to the various sizes and distributions of the particles of the composite material and the second edible material.) While the detailed description here focuses primarily on taste, the person of ordinary skill in the art will appreciate that the compositions described herein can provide other sensations (e.g., smell, color) in a strong yet long-lasting fashion.

Beneficially, in certain embodiments at least about 85%, at least about 90%, or even at least about 95% of the non-uniformly sized particles of the second edible material (i.e., of the first and second pluralities of particles considered together) may have a particle size in the range of from about 5 μm to about 2000 μm, or in the range of from about 10 μm to about 1000 μm, or in the range of from about 35 μm to about 600 μm, or in the range of from about 50 μm to about 350 μm, or in the range of about 5 μm to about 1000 μm, or in the range of about 5 μm to about 600 μm, or in the range of about 5 μm to about 350 μm, or in the range of about 10 μm to about 2000 μm, or in the range of about 10 μm to about 600 μm, or in the range of about 10 μm to about 350 μm, or in the range of about 35 μm to about 2000 μm, or in the range of about 35 μm to about 1000 μm, or in the range of about 35 μm to about 350 μm, or in the range of about 50 μm to about 2000 μm, or in the range of about 50 μm to about 1000 μm, or in the range of about 50 μm to about 600 μm. As the person of ordinary skill in the art will appreciate, each of said pluralities of particles of second edible material will typically have a distribution of particle sizes within said range (although not necessarily extending to the outer limits of said range).

In certain embodiments the average particle size (i.e., the D₅₀) of the second edible material (i.e., of the first and second pluralities of particles considered together) is in the range of from about 5 μm to about 2000 μm, or in the range of from about 10 μm to about 1000 μm, or in the range of from about 35 μm to about 600 μm, or in the range of from about 50 μm to about 350 μm, or in the range of about 5 μm to about 1000 μm, or in the range of about 5 μm to about 600 μm, or in the range of about 5 μm to about 350 μm, or in the range of about 10 μm to about 2000 μm, or in the range of about 10 μm to about 600 μm, or in the range of about 10 μm to about 350 μm, or in the range of about 35 μm to about 2000 μm, or in the range of about 35 μm to about 1000 μm, or in the range of about 35 μm to about 350 μm, or in the range of about 50 μm to about 2000 μm, or in the range of about 50 μm to about 1000 μm, or in the range of about 50 μm to about 600 μm.

As described above, the particles of the second edible material have a non-uniform particle size. For example, in certain embodiments, the D₁₀ of the particles of the second edible material (i.e., considering together the first plurality and the second plurality thereof) is at least about 10 μm, at least about 20 μm at least about 30 μm, at least about 50 μm, at least about 70 μm, at least about 100 μm, at least about 150 μm, or even at least about 200 μm less than the D₉₀ of the particles of the second edible material. In certain embodiments, the D₁₀ of the particles of the second edible material is in the range of about 5 μm to about 200 μm, or about 10 μm to about 150 μm, or about 25 μm to about 100 μm, or about 5 μm to about 200 μm, or about 5 μm to about 100 μm, or about 10 μm to about 200 μm, or about 10 μm to about 150 μm, or about 25 μm to about 200 μm, or about 25 μm to about 150 μm. In certain embodiments, the D₉₀ of the particles of the second edible material is in the range of about 150 μm to about 2000 μm, or about 200 μm to about 1000 μm, or about 300 μm to about 600 μm, or about 150 μm to about 1000 μm, or about 150 μm to about 600 μm, or about 200 μm to about 2000 μm, or about 200 μm to about 600 μm, or about 300 μm to about 2000 μm, or about 300 μm to about 1000 μm Advantageously, the use of a second edible material having a relatively broad particle size distribution can provide for both strong and elongated dissolution profile. Dissolution speed and the time to complete dissolution vary by particle size. Smaller particles dissolve more quickly, but become completely dissolved (and thus stop adding taste) more quickly as well. Larger particles dissolve relatively more slowly but last for a longer time. Use of a broad distribution of particle sizes can be used to provide not only strong but also long-lasting sensory properties. The distribution of the particle sizes of the second edible material can vary, for example, being polydisperse over a wide variety of particle sizes, or being a multimodal distribution.

Further or alternatively beneficially, at least about 85%, at least about 90%, or even at least about 95% of the composite particles in the plurality thereof may have a particle size in the range of from about 35 μm to about 2000 μm, preferably in the range of from about 50 μm to about 1000 μm, further preferably in the range of from about 100 μm to about 700 μm, and more preferably in the range of from about 200 μm to about 500 μm, or in the range of about 35 μm to about 1000 μm, or in the range of about 35 μm to about 700 μm, or in the range of about 35 μm to about 500 μm, or in the range of about 50 μm to about 2000 μm, or in the range of about 50 μm to about 700 μm, or in the range of about 50 μm to about 500 μm, or in the range of about 100 μm to about 2000 μm, or in the range of about 100 μm to about 1000 μm, or in the range of about 100 μm to about 500 μm, or in the range of about 200 μm to about 2000 μm, or in the range of about 200 μm to about 1000 μm, or in the range of about 200 μm to about 700 μm, or in the range of about 200 μm to about 500 μm. Here, too, said plurality of composite particles will typically have a distribution of particle sizes within said range (although not necessarily extending to the outer limits of said range).

In certain embodiments the average particle size (i.e., the D₅₀) of the composite particles is in the range of from about 35 μm to about 2000 μm, preferably in the range of from about 50 μm to about 1000 μm, further preferably in the range of from about 100 μm to about 700 μm, and more preferably in the range of from about 200 μm to about 500 μm, or in the range of about 35 μm to about 1000 μm, or in the range of about 35 μm to about 700 μm, or in the range of about 35 μm to about 500 μm, or in the range of about 50 μm to about 2000 μm, or in the range of about 50 μm to about 700 μm, or in the range of about 50 μm to about 500 μm, or in the range of about 100 μm to about 2000 μm, or in the range of about 100 μm to about 1000 μm, or in the range of about 100 μm to about 500 μm, or in the range of about 200 μm to about 2000 μm, or in the range of about 200 μm to about 1000 μm, or in the range of about 200 μm to about 700 μm.

The composite particles can have, for example, a mass of the core of less than about 45%, less than about 30%, or even less than about 20% as compared to the mass of the overall composite particles. For example, the composite particles can in various embodiments have a mass in the range of about 5% to about 45%, or about 5% to about 30%, or about 5% to about 20%, or about 8% to about 45%, or about 8% to about 30%, or about 8% to about 20%, or about 10% to about 45%, or about 10% to about 30%, or about 10% to about 20%, or about 15% to about 45%, or about 15% to about 30%, or about 15% to about 20%. For certain applications, e.g., use of the edible composition as table-top salt, particle sizes of the composite particles towards the lower end of the aforementioned ranges may be suitable, e.g., from about 50 μm to about 800 μm, preferably from about 100 μm to about 500 μm, further preferably from about 150 μm to about 350 μm, or from about 50 μm to about 500 μm, or from about 50 μm to about 350 μm, or from about 100 μm to about 800 μm, or from about 100 μm to about 350 μm, or from about 150 μm to about 800 μm, or from about 150 μm to about 500 μm. For certain other applications, e.g., certain other uses of the edible composition, such as salt seasoning for baked goods such as pretzels and biscuits and confectionary such as chocolate, a particle size towards the upper end of the range may be suitable, e.g., from about 800 μm to about 5000 μm, preferably from about 1000 μm to about 3500 μm, further preferably from about 1500 μm to about 2500 μm, or from about 800 μm to about 3500 μm, or from about 800 μm to about 2500 μm, or from about 1000 μm to about 5000 μm, or from about 1000 to about 2500 μm, or from about 1500 μm to about 5000 μm, or from about 1500 μm to about 3500 μm. Such sizes are believed to provide an especially desirable ratio of taste to quantity of the second edible materials. The person of ordinary skill in the art will, based on the description provided herein, provide a particle size distribution for the composite particles to provide the overall composition with a desired set of features for a particular application.

Particle sizes as described herein can be measured, for example, by a laser diffraction-based particle size analyser (e.g., available from Beckman Coulter, Inc.), or via conventional sieving methods.

In certain embodiments, free-flowing edible compositions of the disclosure can be substantially formed from the composite particles and the second plurality of the non-uniformly sized particles. For example, in certain embodiments of the free-flowing edible compositions described herein, at least about 50%, at least about 75%, at least about 80%, at least about 85%, at least about 90%, at least about 95%, at least about 98%, at least about 99%, or even at least about 99.5% of the composition is made up of the composite particles and the second plurality of the non-uniformly sized particles. In certain embodiments, a free-flowing edible composition as described herein consists essentially of the composite particles and the second plurality of the non-uniformly sized particles.

In certain embodiments, the compositions described herein can provide relatively high amounts of the second edible material yet remain free-flowing. In certain embodiments of the compositions described herein, the second edible material is present in an amount of at least about 65 wt %, at least about 75 wt %, at least about 80 wt %, at least about 85 wt %, or at least about 90 wt %, for example, in the range of about 65 wt % to about 99 wt %, or about 65 wt % to about 98 wt %, or about 65 wt % to about 97 wt %, or about 65 wt % to about 95 wt %, or about 65 wt % to about 93 wt %, or about 75 wt % to about 99 wt %, or about 75 wt % to about 98 wt %, or about 75 wt % to about 97 wt %, or about 75 wt % to about 95 wt %, or about 75 wt % to about 93 wt %, or about 80 wt % to about 99 wt %, or about 80 wt % to about 98 wt %, or about 80 wt % to about 97 wt %, or about 80 wt % to about 95 wt %, or about 80 wt % to about 93 wt %, or about 85 t % to about 99 wt %, or about 85 wt % to about 98 wt %, or about 85 wt % to about 97 wt %, or about 85 wt % to about 95 wt %, or about 85 wt % to about 93 wt %, or about 90 wt % to about 99 wt %, or about 90 wt % to about 98 wt %, or about 90 wt % to about 97 wt %, or about 90 wt % to about 95 wt %, or about 90 wt % to about 93 wt % of the overall composition.

Indeed, in certain embodiments as described herein, the first and second edible materials can be provided in a ratio (by mass) of at least about 1:3, at least about 1:4, at least about 1:5, at least about 1:7, at least about 1:9, at least about 1:19, at least about 1:29, at least about 1:39, at least about 1:49, or even at least about 1:98. For example, in certain embodiments, the first and second edible materials can be provided in a ratio (by mass) in the range of from about 1:3 to about 1:9, or about 1:3 to about 1:14, about 1:3 to about 1:19, or about 1:3 to about 1:29, or about 1:3 to about 1:39, or about 1:3 to about 1:49, or about 1:3 to about 1:98, or about 1:3 to about 1:99, or about 1:3 to about 1:199, or about 1:4 to about 1:9, or about 1:4 to about 1:14, about 1:4 to about 1:19, or about 1:4 to about 1:29, or about 1:4 to about 1:39, or about 1:4 to about 1:49, or about 1:4 to about 1:98, or about 1:4 to about 1:99, or about 1:4 to about 1:199, or about 1:5 to about 1:9, or about 1:5 to about 1:14, about 1:5 to about 1:19, or about 1:5 to about 1:29, or about 1:5 to about 1:39, or about 1:5 to about 1:49, or about 1:5 to about 1:98, or about 1:5 to about 1:99, or about 1:5 to about 1:199, or about 1:7 to about 1:9, or about 1:7 to about 1:14, about 1:7 to about 1:19, or about 1:7 to about 1:29, or about 1:7 to about 1:39, or about 1:7 to about 1:49, or about 1:7 to about 1:98, or about 1:7 to about 1:99, or about 1:7 to about 1:199, or about 1:9 to about 1:14, about 1:9 to about 1:19, or about 1:9 to about 1:29, or about 1:9 to about 1:39, or about 1:9 to about 1:49, or about 1:9 to about 1:98, or about 1:9 to about 1:99, or about 1:9 to about 1:199

The ratio of composite particles to the second plurality of particles of the second edible material can be varied by the person of ordinary skill in the art. In certain embodiments, the ratio (by mass) of the composite particles to the second plurality of particles is in the range of about 15:85 to about 75:25, for example, in the range of about 35:65 and about 65:35, or about 15:85 to about 65:35, or about 15:85 to about 50:50, or about 35:65 to about 75:25, or about 35:65 to about 50:50, or about 50:50 to about 65:35, or about 50:50 to about 75:25.

Further to the discussion of bulk density earlier in the specification, in certain embodiments as described herein, a free-flowing edible composition according to the disclosure can have a bulk density of at least about 0.6 g/cm³, at least about 0.7 g/cm³, at least about 0.8 g/cm³, or at least about 0.9 g/cm³. For example, in certain embodiments (e.g., when the second edible material is salt), the bulk density of the composition is in the range of about 0.7 to about 1.10 g/cm³, or about 0.8 to about 0.85 g/cm³. A bulk density of this order is beneficial in that it assists with providing non-dusting characteristics to the composition, and the overall flowability and shakeability of the composition.

As will be described in further detail below, discrete, non-uniformly sized particles of the second edible material can be formed over a substantial fraction of the entire available surfaces of the cores of the composite particles. Such a rough surface is beneficial because it increases the available surface area of second edible material (as compared to a more continuous surface for the same-sized particle of first edible material), which aids availability, e.g. dissolution, thereof. Because the coating is discontinuous, it will typically be formed over somewhat less than 100% of the available surface area of the cores. In certain embodiments, however, coverage is desirably maximised in so far as is practical given any limitation on the duration of the overall method. In certain embodiments of the composite particles as described herein, the cores of the composite particles have an average surface coverage (i.e., of particles of the second edible material affixed to the surface of the core) in the range of at least about 70%, at least about 75%, at least about 80%, or at least about 85%, for example, in the range of about 70% to about 95%, or in the range of about 70% to about 90%, or in the range of about 75% to about 95%, or in the range of about 75% to about 90%, or in the range of about 80% to about 95%, or in the range of about 80% to about 90%.

To facilitate a dry manufacturing method, further details of which will be provided below, the first edible material can in certain especially desirable embodiments have a glass transition temperature or softening point substantially lower than the glass transition temperature or softening point of the second edible material. For example, in certain embodiments, the glass transition temperature or softening point of the first edible material is at least about 20° C., at least about 30° C., at least about 50° C., at least about 70° C., at least about 100° C., at least about 150° C. or at least about 200° C. less than the glass transition temperature of the second edible material. This relationship will be considered satisfied when the second edible material does not have a glass transition temperature or softening point below its decomposition temperature (i.e., it does not become soft or sticky before thermally decomposing). This relationship can be important for the methods described herein; when the process is performed at a temperature between the glass transition temperatures/softening points of the two materials, the particles of the second edible material can stick to the particles of the first edible material, but not to one another, so that discrete composite particles can be formed.

In certain advantageous embodiments, the glass transition temperature or softening point of the first edible material is in the range of from about 10° C. to about 120° C., or in the range of from about 20° C. to about 110 CC, or in the range of from about 30° C. to about 90° C., or in the range of from about 10° C. to about 110° C., or in the range from about 10° C. to about 90° C., or in the range of about 20° C. to about 120° C., or in the range of about 20° C. to about 90° C., or in the range of about 30° C. to about 120° C., or in the range of about 30° C. to about 100° C. Of course, as the person of ordinary skill in the art will appreciate, the softening point of the first edible material will depend on its identity and level of hydration. The person of ordinary skill in the art can select appropriate processing conditions and second edible materials for use with first edible materials of a wide variety of glass transition temperatures/softening points.

In certain advantageous embodiments of the compositions described herein, the free moisture content of the overall composition is less than about 10 wt %, less than about 8 wt %, or less than about 5 wt %. In certain embodiments, the free moisture content of the first edible material is less than about 10 wt %, less than about 8 wt %, or less than about 5 wt %. Similarly, in certain embodiments, the free moisture content of the second edible material is less than about 10 wt %, less than about 8 wt %, or less than about 5 wt %. Similarly, in certain embodiments, the free moisture content of the overall composition is less than about 10 wt %, less than about 8 wt %, or less than about 5 wt %. Of course, as the person of ordinary skill in the art will appreciate, the moisture contents of the first and second edible materials will depend strongly on their identity and the ambient conditions. The person of ordinary skill in the art can select appropriate processing conditions, compositional details and storage conditions for materials of a wide variety of moisture levels.

In some embodiments of the compositions as described herein, each composite particle may further comprise at least a third edible material (optionally also a fourth edible material, optionally also a fifth edible material, etc.), which is mixed with the first edible material in the core, around which the discontinuous surface coating is provided. In other words, the composite particles may have a core that is a mixture of the first and at least third edible materials, said core being coated with particles of the second edible material.

In certain such embodiments, the “mixture” of first and at least third edible materials in the core of a composite particle is selected from any of the following:
i. particles of the first and at least third edible materials being co-mingled and substantially evenly co-distributed in the core
ii. particles of at least one of the at least third edible material being dispersed in an amorphous matrix of the first edible material, and vice versa
iii. particles of at least one of the at least third edible material forming an amorphous coating layer or outer shell around the first edible material (provided in particulate or amorphous matrix form), and vice versa.

In certain especially advantageous embodiments, the particles of the second edible material form substantially a single layer on the surface of the cores of the composite particles. In such embodiments, the particles of the second edible material (both at the surfaces of the composite particles and in the loose material of the second plurality of particles of second edible material) can all begin dissolution at substantially the same time; a relatively broad distribution of particle sizes of the second edible material can provide a strong and long-lasting sensory profile as described above.

As will be described in more detail below, the second edible material may have a variety of particular identities. In certain embodiments, the second edible material is formed from a single component, e.g., salt, or a single spice, or a single flavouring. In other embodiments, the second edible material is formed from two or more, i.e. a plurality (e.g., 2, 3 or 4), of particulate components. When the second edible material is formed from a plurality of particulate components, the particles of each component can, for example, be provided with a non-uniform particle sizes (e.g., in substantially similar distributions as one another). Such composite particles formed would have a core of first edible material coated with a coating of a plurality of different components (i.e., as the second material). A second edible material that is formed from a plurality of particulate components can provide a mixed coating on the composite particles, and as such can provide, e.g., an immediate mixture of two tastes (such as salt and pepper) resulting from the comparatively smaller sized particles followed by a prolonged release of the two tastes resulting from the comparatively larger sized particles. Such combinations of a plurality of particulate components can be, for example, salt and one or more herbs or spices, salt and a flavour enhancer such as monosodium glutamate, salt and one or more sweeteners, a mixture of sweeteners (e.g., a combination of sucrose and allulose, a combination of sucrose and a high-intensity sweetener), a sweetener and one or more herbs/spices.

In certain desirable embodiments, at least one of the components, or even each component of the second edible material is a salt. As used herein, “salt” refers not only to sodium chloride, but also to other “salty” tasting salts, such as potassium chloride. In certain embodiments, the salt used in the compositions as described herein is substantially sodium chloride in combination with potassium chloride. In other embodiments, the salt used in the compositions as described herein is substantially sodium chloride.

When the second edible material is formed from a plurality of particulate components, the first edible material preferably has a glass transition temperature or softening temperature that is lower than the glass transition temperature of each of the components of the second edible material. In other words, only the first edible material would soften and become “sticky” whilst each of the components of second edible material would remain “un-sticky”, but would coat the core of first edible material by virtue of the “stickiness” of said first edible material. Thus, the glass transition temperature/softening point relationships described above desirably apply with respect to each of the components of the second edible material.

In some embodiments of the compositions as described herein, the free-flowing edible composition may further include one or more additional edible materials (in addition to the discussion above, where the composition may comprise “at least” a third edible material). Such additional edible materials can be provided, for example, in particulate form, for example, as a plurality of non-uniformly sized particles, a portion of which particles may be intermingled with the second plurality of particles of the second edible material.

As the person of ordinary skill will appreciate, a wide variety of edible materials may be used in the free-flowing edible compositions as described herein. In certain embodiments, the first edible material, the second edible material, or both are substantially water-soluble.

Each of the first and at least third (as applicable) edible materials may be a natural or synthetic edible carrier material, and may include, for example, any one or more of the following:
monosaccharides, e.g. glucose, fructose, galactose, xylose;
disaccharides, e.g. sucrose (e.g. refined sugar), lactose, maltose;
polysaccharides, e.g. starch, maltodextrin, cellulose, soluble corn fiber (e.g., any of the compositions described in U.S. Pat. No. 7,608,436, which is hereby incorporated herein by reference in its entirety), oat-derived polysaccharides;
   and derivatives thereof. Thus, when present together, the first and at least third edible materials may be a mixture of any two or more of these carrier materials. In certain embodiments, the first edible material consists essentially of one of these listed materials or a combination of two or more of these listed materials.

Other carrier materials from which each of the first (and at least third as applicable) edible materials may in certain embodiments be independently selected are described in more detail below.

The first edible material may be, for example, an organic material, preferably a polymeric material. A wide variety of such polymeric materials may be used to produce composite particles in accordance with the disclosure, with preferred polymers having substantial solubility in an aqueous environment. The polymer may be natural or synthetic although the person of ordinary skill in the art will appreciate that it should be a polymer which is acceptable for alimentary purposes.

Examples of natural polymers include carbohydrates, e.g. oligosaccharides or polysaccharides, and proteins. Mixtures of such polymer types may also be used. If the polymer is a carbohydrate then it may, for example, be one or more of maltodextrin (e.g. Fibersol), gum arabic (e.g. acacia gum), starch (e.g. soluble corn starch, potato starch or soya bean starch), Merigel™ (starch), Mira-Mist™ SE (modified starch), Promitor™ Soluble Corn Fiber (e.g., SCF 70 or SCF 85), locust bean gum (e.g. Genu™ locust bean gum), Maltosweet™ 120 (maltodextrin), gellan gum (e.g. Kelcogel™ F), pullulan, xanthan gum (e.g. Keltrol™ xanthan gum) and pectin (e.g. Genu™ pectin), guar gum, carageenan, hydroxypropyl cellulose, agar and the natural polymer Natto which is obtained by fermentation of soya beans using Bacillus subtilis to produce a “sticky product” on the surface of the beans, which may then be mixed with an equal volume of water and homogenised to produce Natto.

In certain embodiments of the methods and compositions as described herein, the first edible material includes, or even consists essentially of soluble corn fiber. Soluble corn fiber is a starch-derived soluble fiber that is made from corn and that comprises oligosaccharides that are digestion-resistant, oligosaccharides that are slowly digestible, or a combination thereof. Soluble corn fiber can be made via corn starch hydrolysis, and contains greater than about 70% fiber and less than about 20% mono- and disaccharide sugars. The glucose units of the oligosaccharides are linked primarily by α-1,4 glycosidic bonds, but can also include α-1,6, α-1,3, and α-1,2 bonds.

In certain embodiments of the methods and compositions described herein, the soluble corn fiber has a fiber content in the range of about 70% to about 100% (w/w). In another embodiment, the fiber content of the soluble corn fiber is in the range of about 70% to about 90%, or about 70% to about 95%, or about 70% to about 100%, about 75% to about 85%, or about 75% to about 90%, or about 75% to about 95%, or about 75% to about 100%, or about 70% to about 85% (w/w). In one embodiment, the fiber content is about 70% (w/w). In another embodiment, the fiber content is about 85% (w/w). One of skill in the art will appreciate that fiber content may be measured by any suitable method known in the art, such as enzymatic gravimetry, liquid chromatography, gas-liquid chromatography, High Pressure Liquid chromatography (HPLC), High Performance Anion Exchange Chromatography with Pulsed Amperometric Detection (HPAE-PAD), and other enzymatic and chemical methods. In a preferred embodiment, the fiber content is measured by HPAE-PAD. For example, a Dionex ion chromatograph, DX500, equipped with electrochemical detector and gradient pump, is used to analyze samples that are separated on Dionex Carbopac PAI analytical and guard columns with gradient delivery of solvents, detected using a gold electrode with a four-potential waveform, and diluted with water and passed through Amicon Ultra-4 centrifugal filter devices before analysis.

In certain embodiments of the methods and compositions described herein, the mono- and disaccharide content of the soluble corn fiber is less than about 20%. For example, in certain embodiments, the mono- and disaccharide content of the soluble corn fiber is less than about 15%, less than about 10%, less than about 5%, or even less than about 2%. In certain such embodiments, the mono- and disaccharide content of the soluble corn fiber is no less than about 0%, no less than about 0.001%, no less than about 0.01%, or even no less than 0.1%.

In certain embodiments of the methods and compositions described herein, the oligosaccharides of the soluble corn fiber have an average degree of polymerization of at least about 5, at least about 7, or at least about 9. For example, in certain embodiments of the methods and compositions described herein, the oligosaccharides of the soluble corn fiber have an average degree of polymerization in the range of about 5 to about 20, about 7 to about 20, or about 9 to about 20. In other embodiments, the oligosaccharides of the soluble corn fiber have an average degree of polymerization in the range of about 5 to about 15, about 7 to about 15, or about 9 to about 15. For example, in one embodiment the methods and compositions described herein, the oligosaccharides of the soluble corn fiber have an average degree of polymerization is about 10.

In certain embodiments of the methods and compositions described herein, the oligosaccharide portion of the soluble corn fiber remains substantially undigested in the stomach and small intestine of a subject when ingested.

Suitable commercial soluble corn fiber products include PROMITOR™ Soluble Corn Fiber 70 (minimum fiber content of about 70%, maximum mono- and disaccharide content of about 20%), and PROMITOR™ Soluble Corn Fiber 85 (minimum fiber content of about 85%, maximum mono- and disaccharide content of about 2%), available from Tate & Lyle Health & Nutrition Sciences, Hoffman Estates, IL.

Certain soluble corn fibers suitable for use in the methods and compositions described herein are described further in U.S. Pat. Nos. 7,608,436, and 8,057,840, each of which is hereby incorporated herein by reference in its entirety. In certain embodiments of the methods and compositions described herein, the soluble corn fiber is as described in an aspect or embodiment of U.S. Pat. Nos. 7,608,436, and 8,057,840.

In certain embodiments of the methods and compositions as described herein, the soluble corn fiber is produced by a process described in U.S. Pat. Nos. 7,608,436, and 8,057,840, each of which is hereby incorporated herein by reference in its entirety. For example, in one embodiment, the process to produce the soluble corn fiber includes uses an aqueous feed composition that comprises at least one monosaccharide or linear saccharide oligomer, and that has a solids concentration of at least about 70% by weight. The feed composition is heated to a temperature of at least about 40° C., and is contacted with at least one catalyst that accelerates the rate of cleavage or formation of glucosyl bonds for a time sufficient to cause formation of non-linear saccharide oligomers. In one particular embodiment, the process includes heating an aqueous feed composition that comprises at least one monosaccharide or linear saccharide oligomer, and that has a solids concentration of at least about 70% by weight, to a temperature of at least about 40° C.; and contacting the feed composition with at least one catalyst that accelerates the rate of cleavage or formation of glucosyl bonds for a time sufficient to cause formation of non-linear saccharide oligomers, wherein a product composition is produced that contains a higher concentration of non-linear saccharide oligomers than linear saccharide oligomers; wherein the product composition comprises non-linear saccharide oligomers having a degree of polymerization of at least three in a concentration of at least about 20% by weight on a dry solids basis. In certain such embodiments, the product composition is produced that contains a higher concentration of non-linear saccharide oligomers than linear saccharide oligomers. In one embodiment of the process, the at least one catalyst is an enzyme that accelerates the rate of cleavage or formation of glucosyl bonds. In another embodiment of the process, the at least one catalyst is an acid. In some embodiments of the process, acid and enzyme can be used in sequence, with the feed composition first being treated with enzyme and subsequently with acid, or vice versa.

In certain embodiments of the processes as described with respect to U.S. Pat. Nos. 7,608,436, and 8,057,840, the aqueous feed composition includes at least one monosaccharide and at least one linear saccharide oligomer, and may contain several of each. In many cases, monosaccharides and oligosaccharides will make up at least about 70% by weight on a dry solids basis of the feed composition. It is generally helpful for the starting material to have as high a concentration of monosaccharides as possible, in order to maximize the yield of the desired oligomers. A high solids concentration tends to drive the equilibrium from hydrolysis toward condensation (reversion), thereby producing higher molecular weight products. Therefore the water content of the starting material is preferably relatively low. For example, in certain embodiments, the feed composition comprises at least about 75% dry solids by weight. (“Dry solids” is sometimes abbreviated herein as “ds.”). In some cases, the feed composition comprises about 75-90% solids by weight, which will generally give the appearance of a viscous syrup or damp powder at room temperature.

Examples of suitable starting materials for the processes as described with respect to U.S. Pat. Nos. 7,608,436, and 8,057,840 include, but are not limited to, syrups made by hydrolysis of starch, such as dextrose greens syrup (i.e., recycle stream of mother liquor from dextrose monohydrate crystallization), other dextrose syrups, corn syrup, and solutions of maltodextrin. If the feed composition comprises maltodextrin, the process optionally can also include the steps of hydrolyzing the maltodextrin to form a hydrolyzed saccharide solution and concentrating the hydrolyzed saccharide solution to at least about 70% dry solids to form the feed composition. The concentrating and the contacting of the feed with the catalyst can occur simultaneously, or the concentrating can occur prior to contacting the feed composition with the catalyst.

In certain embodiments of the processes as described with respect to U.S. Pat. Nos. 7,608,436, and 8,057,840, the feed composition is contacted with the at least one catalyst for a period of time that can vary. In some cases, the contacting period will be at least about five hours. In some embodiments of the disclosure, the feed composition is contacted with the at least one catalyst for about 15-100 hours. In other embodiments, shorter contacting times can be used with higher temperatures, in some cases even less than one hour.

In certain embodiments of the processes as described with respect to U.S. Pat. Nos. 7,608,436, and 8,057,840, enzymatic reversion is used to produce nonlinear oligosaccharides. The enzyme can be, for example, one that accelerates the rate of cleavage of alpha 1-2, 1-3, 1-4, or 1-6 glucosyl bonds to form dextrose residues. One suitable example is a glucoamylase enzyme composition, such as a commercial enzyme composition that is denominated as a glucoamylase. It should be understood that such a composition can contain some quantity of enzymes other than pure glucoamylase, and it should not be assumed that it is in fact glucoamylase itself that catalyzes the desired production of nonlinear oligosaccharides. Therefore, the feed composition can be contacted with glucoamylase or any other enzyme that acts on dextrose polymers. The amount of enzyme can suitably be about 0.5-2.5% by volume of the feed composition. In some embodiments of the process, the feed composition is maintained at about 55-75° C. during the contacting with the enzyme, or in some cases about 60-65° C. At this temperature, depending on the water content, the material will become a liquid, or a mixture of liquid and solid. Optionally, the reaction mixture can be mixed or agitated to distribute the enzyme. The reaction mixture is maintained at the desired temperature for the time necessary to achieve the desired degree of reversion to non-linear oligomers. In some embodiments of the process, the feed composition is contacted with the enzyme for about 20-100 hours prior to inactivation of the enzyme, or in some cases, for about 50-100 hours prior to inactivation. Techniques for inactivating glucoamylase are well known in the field. Alternatively, instead of inactivating the enzyme, it can be separated by membrane filtration and recycled.

In certain embodiments of the processes as described with respect to U.S. Pat. Nos. 7,608,436, and 8,057,840, the resulting composition has a high concentration of non-linear oligosaccharides, such as isomaltose. This product composition contains a higher concentration of non-linear saccharide oligomers than linear saccharide oligomers. In some cases, the concentration of non-linear saccharide oligomers in the final composition is at least twice as high as the concentration of linear saccharide oligomers.

Another embodiment of processes as described with respect to U.S. Pat. Nos. 7,608,436, and 8,057,840 involves acid reversion of monosaccharides. The starting material is the same as described above with respect to the enzyme version of the process. A variety of acids can be used, such as hydrochloric acid, sulfuric acid, phosphoric acid, or a combination thereof. In some embodiments of the process, acid is added to the feed composition in an amount sufficient to make the pH of the feed composition no greater than about 4, or in some cases, in an amount sufficient to make the pH of the feed composition about 1.0-2.5, or about 1.5-2.0. In some embodiments, the solids concentration of the feed composition is about 70-90%, the amount of acid added to the feed is about 0.05%-0.25% (w/w) acid solids on syrup dry solids, and the feed composition is maintained at a temperature of about 70-90° C. during the contacting with the acid. As in the enzyme version of the process, the reaction conditions are maintained for a time sufficient to produce the desired oligomers, which in some embodiments of the process will be about 4-24 hours.

In one particular embodiment of the processes described with respect to U.S. Pat. Nos. 7,608,436, and 8,057,840, the solids concentration of the feed composition is at least about 80% by weight, acid is added to the feed composition in an amount sufficient to make the pH of the composition about 1.8, and the feed composition is maintained at a temperature of at least about 80° C. for about 4-24 hours after it is contacted with the acid.

In another particular embodiment of the processes described with respect to U.S. Pat. Nos. 7,608,436, and 8,057,840, the solids concentration of the feed composition is about 90-100% by weight, and the feed composition is maintained at a temperature of at least about 149° C. (300° F.) for about 0.1-15 minutes after it is contacted with the acid. The acid used to treat the feed can be a combination of phosphoric acid and hydrochloric acid (at the same concentrations discussed above). In one particular embodiment, the contacting of the feed composition with the acid takes place in a continuous pipe/flow through reactor.

By far the most plentiful glycosidic linkage in starch is the alpha-1,4 linkage, and this is the linkage most commonly broken during acid hydrolysis of starch. But acid-catalyzed reversion (condensation) can take place between any two hydroxyl groups, and, given the large variety of combinations and geometries available, the probability of an alpha-1,4 linkage being formed is relatively small. The human digestive system contains alpha amylases which readily digest the alpha-1,4 linkages of starch and corn syrups. Replacing these linkages with linkages unrecognized by enzymes in the digestive system will allow the product to pass through to the small intestines largely unchanged. The saccharide distributions resulting from acid treatment are believed to be somewhat different than from enzyme treatment. It is believed that these acid-catalyzed condensation products will be less recognizable by the enzymes in the human gut than enzyme-produced products, and therefore less digestible.

The acid treatment progresses differently than enzyme treatment. Enzymes rapidly hydrolyze linear oligomers and slowly form non-linear oligomers, whereas with acid the reduction in linear oligomers and the increase in non-linear oligomers occur at comparable rates. Dextrose is formed rapidly by enzymatic hydrolysis of oligomers, and consumed slowly as non-linear condensation products are formed, whereas with acid dextrose concentrations increase slowly.

Optionally, in certain embodiments of the processes described with respect to U.S. Pat. Nos. 7,608,436, and 8,057,840, enzymatic or acid reversion can be followed by hydrogenation. The hydrogenated product should have lower caloric content than currently available hydrogenated starch hydrolysates. In one embodiment, the hydrogenation can be used to decolorize the product composition without substantially changing its dextrose equivalence (DE). In one version of the process, enzyme and acid can be used sequentially, in any order. For example, the at least one catalyst used in the first treatment can be enzyme, and the product composition can be subsequently contacted with an acid that accelerates the rate of cleavage or formation of glucosyl bonds. Alternatively, the at least one catalyst used in the first treatment can be acid, and the product composition can be subsequently contacted with an enzyme that accelerates the rate of cleavage or formation of glucosyl bonds.

The product composition produced by the treatment with acid, enzyme, or both, has an increased concentration on a dry solids basis of non-linear saccharide oligomers. In some cases, the concentration of non-linear saccharide oligomers having a degree of polymerization of at least three (DP3+) in the product composition is at least about 20%, at least about 25%, at least about 30%, or at least about 50% by weight on a dry solids basis. In certain such embodiments, the concentration of non-linear saccharide oligomers having a degree of polymerization of at least three (DP3+) in the product composition is no more than about 100%, or no more than about 99%, or no more than about 95%, or no more than about 90% by weight on a dry solids basis. In some embodiments, the concentration of non-linear saccharide oligomers in the product composition is at least twice as high as the concentration of linear saccharide oligomers.

In one particular embodiment of the processes described with respect to U.S. Pat. Nos. 7,608,436, and 8,057,840, the concentration of non-linear saccharide oligomers in the product composition is at least about 90% by weight on a dry solids basis, and the concentration of isomaltose is at least about 70% by weight on a dry solids basis.

The product composition will often contain some quantity (typically less than 50% by weight on a dry solids basis, and often much less) of residual monosaccharides. Optionally, at least some of the residual monosaccharides (and other species) can be separated from the oligomers (for example by membrane filtration, chromatographic separation, or digestion via fermentation) and the monosaccharide stream can be recycled into the process feed. In this way, simple sugar syrups can be converted to high-value food additives.

In one embodiment of a process which can make use of the reversion technique described above, the process can begin with a starch, for example a vegetable starch. Conventional corn starch is one suitable example. The process will generally operate more efficiently if the beginning starch has a relatively high purity. In one embodiment, the high purity starch contains less than 0.5% protein on a dry solids basis. The starch can have acid added to it and can then be gelatinized in a starch cooker, for example in a jet cooker in which starch granules are contacted with steam. In one version of the process, the starch slurry, adjusted to a pH target of 3.5 by addition of sulfuric acid, is rapidly mixed with steam in a jet cooker and held at 149 to 152° C. (300 to 305° F.) for 4 minutes in a tail line. The gelatinized starch is hydrolyzed by exposure to acid at high temperature during jet cooking. The hydrolysis reduces the molecular weight of the starch and generates an increased percentage of monosaccharides and oligosaccharides in the composition. (As mentioned above, the term “oligosaccharides” is used herein to refer to saccharides comprising at least two saccharide units, for example saccharides having a degree of polymerization (DP) of about 2-30.) A neutralizing agent, such as sodium carbonate, can be added to stop the acid hydrolysis, and then the composition can be further depolymerized by contacting it with a hydrolytic enzyme. Suitable enzymes include alpha amylases such as Termamyl, which is available from Novozymes. This enzymatic hydrolysis further increases the percentage of monosaccharides and oligosaccharides present in the composition. The overall result of the hydrolysis by acid and enzyme treatment is to saccharify the starch. The saccharified composition can be isomerized to change the monosaccharide profile, for example to increase the concentration of fructose.

The saccharified composition can then be purified, for example by chromatographic fractionation. In one embodiment that employs a sequential simulated moving bed (SSMB) chromatography procedure, a solution of mixed saccharides is pumped through a column filled with resin beads. Depending on the chemical nature of the resin, some of the saccharides interact with the resin more strongly leading to a retarded flow through the resin compared to saccharides that interact with the resin more weakly. This fractionation can produce one stream 30 that has a high content of monosaccharides, such as dextrose and fructose. High fructose corn syrup is an example of such a stream. The fractionation also produces a raffinate stream (i.e., faster moving components through the resin bed) that has a relatively high concentration of oligosaccharides (e.g., about 5-15% oligosaccharides on a dry solids basis (d.s.b.)) and also contains a smaller concentration of monosaccharides such as dextrose and fructose. Although the term “stream” is used herein to describe certain parts of the process, it should be understood that the process of the present disclosure is not limited to continuous operation. The process can also be performed in batch or semi-batch mode.

The raffinate can be further fractionated by membrane filtration, for example by nanofiltration, optionally with diafiltration. For example, these filtration steps can be performed using a Desal DK spiral wound nanofiltration cartridge at about 3.45 MPa (500 psi) of pressure and at 40-60 degrees centigrade temperature. The fractionation described in step could also be accomplished by sequential simulated moving bed chromatography (SSMB). The membrane filtration produces a permeate (i.e., components that pass through the membrane) which comprises primarily monosaccharides, and a retentate (i.e., components rejected by the membrane) which comprises primarily oligosaccharides. (“Primarily” as used herein means that the composition contains more of the listed component than of any other component on a dry solids basis.) The permeate can be combined with the monomer stream (e.g., high fructose corn syrup). The permeate is a monosaccharide-rich stream and the retentate is an oligosaccharide-rich stream. In other words, the nanofiltration concentrates the oligosaccharides in the retentate and the monosaccharides in the permeate, relative to the nanofiltration feed.

The retentate, which can be described as an oligosaccharide syrup, can have a sufficiently high content of oligosaccharides that are slowly digestible (e.g., at least about 50% by weight d.s.b., or in some cases at least about 90%) so that it can be dried or simply evaporated to a concentrated syrup and used as an ingredient in foods. However, in many cases, it will be useful to further process and purify this composition. Such purification can include one or more of the steps described in the following paragraphs.

The oligomers syrup can be subjected to another fractionation, such as a membrane filtration, for example a second nanofiltration, in order to remove at least some of the residual monosaccharides, such as fructose and dextrose. Suitable nanofiltration conditions and equipment are as described above. This nanofiltration produces a permeate, which is a second monosaccharide-rich stream, which can be combined with the monomer stream. Alternatively, the further fractionation could be done by chromatographic separation, for example, by simulated mixed-bed chromatography.

The syrup can be isomerized by contacting it with an enzyme such as dextrose isomerase. This will convert at least some of the residual dextrose present into fructose, which may be more valuable in certain situations.

The syrup can be treated with an enzyme or acid to cause reversion or repolymerization, in which at least some of the monosaccharides that are still present are covalently bonded to other monosaccharides or to oligosaccharides, thereby reducing the residual monomer content of the syrup even further. Suitable enzymes for use in this step include glucosidases, such as amylase, glucoamylase, transglucosidase, and pullulanase. Cellulase enzymes may produce valuable reversion products for some applications.

The syrup can be hydrogenated to convert at least some of any residual monosaccharides to the corresponding alcohols (e.g., to convert dextrose to sorbitol). When hydrogenation is included in the process, it will typically (but not necessarily) be the final purification step.

The purified oligomer syrup produced by one or more of the above purification steps can then be decolorized. Decolorization can be done by treatment with activated carbon followed by microfiltration, for example. In continuous flow systems, syrup streams can be pumped through columns filled with granular activated carbon to achieve decolorization. The decolorized oligomer syrup can then be evaporated, for example to about greater than about 70% dry solids (d.s.), giving a product that comprises a high content of oligosaccharides (e.g., greater than 90% by wt d.s.b., and in some instances greater than 95%), and a correspondingly low monosaccharide content. The product comprises a plurality of saccharides which are slowly or incompletely digested by humans, if not totally indigestible. These sugars can include isomaltose, panose and branched oligomers having a degree of polymerization of four or greater.

The process conditions can be modified to recover the majority of the maltose in the feed either in the monomer-rich streams or in the oligomer product stream. For example, a nanofiltration membrane with a slightly larger pores, such as Desal DL, operating at less than 3.45 MPa (500 psi) pressure can be used to increase the amount of maltose in monomer-rich streams.

In certain embodiments of the methods and compositions as described herein, the soluble corn is a slowly digestible saccharide oligomer composition that is suitable for use in foods. “Slowly digestible” as the term is used herein means that one or more carbohydrates are either not digested at all in the human stomach and small intestine, or are only digested to a limited extent. Both in vitro and in vivo tests can be performed to estimate the rate and extent of carbohydrate digestion in humans. The “Englyst Assay” is an in vitro enzyme test that can be used to estimate the amounts of a carbohydrate ingredient that are rapidly digestible, slowly digestible or resistant to digestion (European Journal of Clinical Nutrition (1992) Volume 46 (Suppl. 2), pages S33-S50). Thus, any reference herein to “at least about 50% by weight on a dry solids basis” of a material being “slowly digestible” means that the sum of the percentages of that material that are classified as slowly digestible or as resistant by the Englyst assay totals at least about 50%. The terms “oligosaccharides” and “saccharide oligomers” are used herein to refer to saccharides comprising at least two saccharide units, for example saccharides having a degree of polymerization (“DP”) of about 2-30. For example, a disaccharide has a DP of 2.

Gastrointestinal enzymes readily recognize and digest carbohydrates in which the dextrose units are linked alpha (1→4) (“linear” linkages). Replacing these linkages with alternative linkages (alpha (1—3), alpha (1—6) (“non-linear” linkages) or beta linkages, for example) greatly reduces the ability of gastrointestinal enzymes to digest the carbohydrate. This will allow the carbohydrates to pass on into the small intestines largely unchanged. In certain embodiments of the methods and compositions as described herein, the soluble corn fiber, e.g., the soluble corn fiber, comprises a minor amount (i.e., less than 50 wt % on a dry solids basis, and usually a much lower concentration, e.g., less than 40 wt %, less than 30 wt %) of residual monosaccharides. In some embodiments as described herein, at least about 50% by weight on a dry solids basis of the product composition is slowly digestible. The processes as described with respect to U.S. Pat. Nos. 7,608,436, and 8,057,840 can include the additional step of removing at least some of the residual monosaccharides (and optionally other species as well) from the product composition by membrane filtration, chromatographic fractionation, or digestion via fermentation. The separated monosaccharides can be combined with other process streams, for example for production of dextrose or corn syrup. Alternatively, the separated monosaccharides can be recycled into the feed composition.

In certain embodiments of the methods and compositions as described herein, the soluble corn fiber comprises a major amount (e.g., greater than 50%, greater than about 60%, or greater than about 70%) on a dry solids basis of linear and non-linear saccharide oligomers, and wherein the concentration of non-linear saccharide oligomers is greater than the concentration of linear saccharide oligomers, and wherein the concentration of non-linear saccharide oligomers having a degree of polymerization of at least three is at least about 20% by weight on a dry solids basis. For example, in certain embodiments, the concentration of non-linear saccharide oligomers in the composition is at least twice as high as the concentration of linear saccharide oligomers. In certain embodiments, the concentration of non-linear saccharide oligomers having a degree of polymerization of at least three is at least about 25% by weight on a dry solids basis. In certain embodiments, the concentration of non-linear saccharide oligomers having a degree of polymerization of at least three is at least about 30% by weight, or even at least 50% by weight, on a dry solids basis. In certain embodiments, wherein the concentration of non-linear saccharide oligomers is at least about 90% by weight on a dry solids basis, and the concentration of isomaltose is at least about 70% by weight on a dry solids basis.

Although organic polymeric materials (that are solid at ambient temperature) are preferred, other organic materials may be used, e.g. fats such as plant or animal derived fats.

Examples of synthetic polymers that may be used include polyethylene glycol. The polyethylene glycol may, for example, have a molecular weight in the range 200-9,500.

As described above, at least one of the at least third edible material, when present, can in certain embodiments be selected from the materials described above with respect to the first edible material. Of course, in other embodiments, at least one of the at least third edible material can be a different material than those described above. Each of the third, fourth, fifth, etc. edible materials may be the same or different from one another. For example, in certain embodiments, the at least third edible material can be a material as described below with respect to the second edible material. In such embodiments, the first edible material desirable forms the substantial portion of the surface of the core (e.g., at least about 80%, at least about 90%, at least about 95%, at least about 98%, or even at least about 99%).

Each component of the second edible material may in certain embodiments be a natural or synthetic flavouring, colorant and/or preservative, i.e. the components of the second and further (as applicable) edible materials each might provide any one or more of these functions. Each component of the second edible material may be the same as, or different to, any one or more of the other components making up the second edible material.

Preferably, the second edible material may include, or even consist essentially of any one or more of the following:
salt, e.g., sodium chloride, potassium chloride, or a mixture thereof;
garlic, onion;
taste enhancers, e.g. high potency sweeteners, yeast extract, monosodium glutamate;
culinary herbs and spices, e.g. cinnamon, saffron, black, white or green pepper;
monosaccharides, e.g. glucose, fructose, galactose, xylose;
disaccharides, e.g. sucrose (e.g. refined sugar), lactose, maltose;
oligosaccharides, e.g. maltodextrin; and derivatives thereof. Thus, the second edible material may be a single of these materials, or a mixture of any two or more of these materials.

Particular natural and synthetic flavourings from which the second edible material may in certain embodiments be independently selected are described in more detail below.

In certain embodiments of compositions as described herein, the second edible material may include, or even consist essentially of a component selected from:
a sweetener;
a natural high potency sweetener;
a synthetic high-potency sweetener that is a glycoside; and
a synthetic high-potency sweetener that is derived from an amino acid.

For example, in one particular embodiment of the compositions described herein, the second edible material may include, or even consist essentially of a component selected from the group consisting of: a nutritive sweetener, aspartame, acesulfame, cyclamate, saccharin and sucralose; and salts and/or solvates thereof.

In particular, the nutritive sweetener may in certain embodiments be one or more selected from the group consisting of: a 3- to 12-carbon sugar alcohol (e.g. allose, deoxyribose, erythrulose, galactose, gulose, idose, lyxose, mannose, ribose, tagatose, talose, xylose, erythrose, fuculose, gentiobiose, gentiobiulose, isomaltose, isomaltulose, kojibiose, lactulose, altrose, laminaribiose, arabinose, leucrose, fucose, rhamnose, sorbose, maltulose, mannobiose, mannosucrose, melezitose, melibiose, melibiulose, nigerose, raffinose, rutinose, rutinulose, sophorose, stachyose, threose, trehalose, trehalulose, turanose, xylobiose), invert sugar, arabitol, glycerol, hydrogenated starch hydrolysate, isomalt, lactitol, maltitol, mannitol, sorbitol and xylitol; allulose (also known as D-psicose), glucose, erythritol, fructose and sucrose; and salts and/or solvates thereof.

The term “sweetener” as used herein refers to a substance that provides a sweet taste. In other words, the sweetener is a nutritive sweetener or a non-nutritive sweetener. However, in particular embodiments, the sweetener does not contain a sugar or a sugar alcohol. In other words, in particular embodiments, the sweetener is a non-nutritive sweetener, which refers to a sweetener that offers little to no calories when ingested.

The term “nutritive sweetener” as used herein refers to a sweetener that contains carbohydrate and provides energy. Nutritive sweeteners may be further classified into monosaccharides or disaccharides, which impart 4 kcal/g, or sugar alcohols (polyols), which provide an average of 2 kcal/g, as discussed in “Position of the American Dietetic Association: Use of nutritive and nonnutritive sweeteners” J. Am. Diet Assoc. 2004; 104(2):255-275.

The term “natural high potency sweetener” as used herein refers to a high potency sweetener obtained from a natural source. For example, a natural high potency sweetener may be used in its raw form (e.g. as a plant) or may be extracted or purified from the natural source. Natural high potency sweeteners include abrusoside A, baiyunoside, brazzein, curculin, cyclocarioside I, glycyphyllin, glycyrrhizic acid, hernandulcin, a Luo Han Guo extract, mabinlin, monatin, monellin, mukurozioside, osladin, periandrins, phlomisosides, phloridzin, phyllodulcin, polypodoside A, pterocaryoside A, pterocaryoside B, rubusoside, a stevia extract (e.g. steviol glycosides, or particularly a rebaudioside, such as rebaudioside A to F, M, N and X), thaumatin and trilobatin, and salts and/or solvates thereof.

The term “synthetic high potency sweetener” as used herein refers to a high potency sweetener that has been produced using one or more synthetic steps. Synthetic high potency sweeteners that may be mentioned in certain embodiments of the disclosure include alitame, aspartame, a glucosylated steviol glycoside, N-[N-[3-(3-hydroxy-4-methoxyphenyl)propyl]-L-[alpha]-aspartyl]-L-phenylalanine 1-methyl ester, N-[N-[3-(3-hydroxy-4-methoxyphenyl)-3-methylbutyl]-L-[alpha]-aspartyl]-L-phenylalanine 1-methyl ester, N-[N-[3-(3-methoxy-4-hydroxyphenyl)propyl]-L-[alpha]-aspartyl]L-phenylalanine 1-methyl ester, neohesperidin, dihydrochalcone, and neotame, and salts and/or solvates thereof.

The term “high-potency sweetener that is a glycoside” as used herein refers to a high potency sweetener that is a molecule in which a sugar is bound to an organic moiety that is not itself a sugar. High-potency sweeteners that are glycosides include abrusoside A, baiyunoside, cyclocarioside I, dulcoside A, dulcoside B, glycyphyllin, glycyrrhizic acid, a glucosylated steviol glycoside, mogrosides (e.g. mogroside IV, mogroside V), mukurozioside, neomogroside, osladin, periandrins, phlomisosides, phloridzin, polypodoside A, pterocaryoside A, pterocaryoside B, a rebaudioside (e.g. rebaudioside A, rebaudioside B, rebaudioside C, rebaudioside D, rebaudioside E, rebaudioside F, rebaudioside M, rebaudioside N, rebaudioside X), rubusoside, siamenoside, stevia, stevioside, trilobatin and neohesperidin dihydrochalcone.

The term “high-potency sweetener that is derived from an amino acid” as used herein refers to high potency sweetener that contains at least one amino acid as part of its molecular structure. High potency sweeteners that are derived from an amino include monatin (e.g. monatin, monatin SS, monatin RR, monatin RS, monatin SR), N-[N-[3-(3-hydroxy-4-methoxyphenyl)propyl]-L-[alpha]-aspartyl]-L-phenylalanine 1-methyl ester, N-[N-[3-(3-hydroxy-4-methoxyphenyl)-3-methylbutyl]L-[alpha]-aspartyl]-L-phenylalanine 1-methyl ester and N-[N-[3-(3-methoxy-4-hydroxyphenyl)propyl]L-[alpha]-aspartyl]L-phenylalanine 1-methyl ester, and salts and/or solvates thereof.

The term “Monk Fruit extract” or “Luo Han Guo extract” as used herein refers to an extract or sample taken from a Monk Fruit from the Monk Fruit plant (i.e. a Luo Han Guo fruit from a Luo Han Guo plant), Siraitia grosvenorii, comprising at least one mogroside. The term “mogroside composition” as used herein refers to a composition comprising at least one mogroside.

The term “mogroside” as used herein refers to a family of compounds found in plants such as Monk Fruit, also known as Luo Han Guo. Mogrosides are glycosides of cucurbitane derivatives.

In various advantageous embodiments of the compositions described herein, the edible compositions may comprise any of the following first edible material/second edible material combinations:
crystalline fructose (e.g. Krystar™)/cinnamon, to provide a source of nutritive sweetener along with flavouring, e.g. for use as a cake-baking ingredient which exhibits reduced clumping;
mixture of soluble corn fiber and maltodextrin/salt and pepper, to provide dietary fiber along with flavouring, e.g. for use as a table-top seasoning replacement product;
soluble corn fiber/salt, to provide a source of dietary fiber along with flavouring/taste enhancement, e.g. for use as a breakfast cereal-manufacturing ingredient;
soluble corn fiber/salt derivative, such as Soda-Lo™ salt microspheres, to provide a source of dietary fiber along with flavouring/taste enhancement, e.g. for use as a bread-making ingredient;
sucrose/allulose (a by-product of the fermentation of molasses), to provide a source of sweetness and energy, e.g. for use as a table-top refined sugar replacement product.

In certain particular embodiments of the compositions as described herein, the second edible material includes, consists essentially of, or is salt (e.g., sodium chloride, potassium chloride, or a mixture of sodium chloride and potassium chloride). In certain such embodiments, the first edible material includes, consists essentially of, or is an oligosaccharide or a polysaccharide, e.g., an oligosaccharide or polysaccharide as described above.

An edible composition according to the disclosure may be provided, for example, as a substitute for, or as a co-ingredient to, currently available food ingredients such as table-top (shaker) salt, table-top pepper, table-top sugar, etc, for use in the home, in restaurants and other food delivery/preparation facilities.

For the avoidance of any doubt, it should be understood that any and all of the aforementioned embodiments and features of the disclosure are combinable with one another.

According to a second aspect of the disclosure, there is provided a foodstuff or a beverage, which is seasoned, coloured and/or preserved with a free-flowing edible composition as hereinbefore described. Such foodstuffs include: potato and corn chips, salted peanuts, pretzels, bagels, salted confectionary, cookies (biscuits), breads, cakes, etc. Of course, the person of ordinary skill in the art will appreciate that the edible compositions need not remain free-flowing in such foodstuffs or beverages.

According to a third aspect of the disclosure there is provided a method of seasoning, colouring and/or preserving a foodstuff or a beverage comprising applying to, or incorporating in, the foodstuff or the beverage a free-flowing edible composition as hereinbefore described. As above, the person of ordinary skill in the art will appreciate that the edible compositions need not remain free-flowing in such foodstuffs or beverages.

According to a fourth aspect of the disclosure there is provided a method of producing a foodstuff or a beverage comprising preparing a precursor of the foodstuff or beverage, incorporating the free-flowing edible composition as hereinbefore described, and cooking the precursor to produce the foodstuff or the beverage. This aspect of the disclosure may provide methods of producing foodstuffs such as snack chips such as potato and corn chips (crisps), salted nuts such as peanuts, peanuts, pretzels, bagels, salted confectionary, cookies (biscuits), breads, cakes, nutrition bars, fried potatoes, etc. Here, too, the person of ordinary skill in the art will appreciate that the edible compositions need not remain free-flowing in such foodstuffs or beverages.

According to a fifth aspect of the disclosure there is provided a method of topically seasoning a foodstuff comprising applying to the foodstuff a free-flowing edible composition as hereinbefore described. Thus, another aspect of the disclosure is a foodstuff having disposed on its surface an edible composition as described herein. (Such composition need not be free-flowing when disposed on the surface of the foodstuff; in many embodiments it will be resistantly held by the surface of the foodstuff, i.e., so that it does not easily slide off of the surface). Such foodstuffs include, for example, snack chips such as potato and corn chips, salted nuts such as peanuts, pretzels, bagels, salted confectionary, cookies (biscuits), crackers, breads, cakes, nutrition bars, etc. Other foodstuffs that can be topically seasoned (e.g., by a consumer) include meats, fishes, fruits and vegetables (e.g., fried potatoes).

According to a sixth aspect of the disclosure there is provided a method of tenderising, curing, plumping or seasoning meats with a free-flowing edible composition, wherein said composition is provided by a free-flowing edible composition as hereinbefore described.

According to a seventh aspect of the disclosure there is provided a method of canning or pickling a foodstuff using a free-flowing edible composition, wherein said composition is provided by a free-flowing edible composition as hereinbefore described. Such a method is particularly, but not exclusively, suited for canning or pickling vegetables, fish and fish products.

According to an eighth aspect of the disclosure there is provided a method of reducing the amount consumed per unit measure of a foodstuff or beverage ingredient, such as a seasoning, colouring and/or preserving agent, used on or in a foodstuff or beverage to be consumed, said method comprising replacing a unit measure of the ingredient with a unit measure of a free-flowing composition as hereinbefore described which comprises said ingredient as the second edible material thereof.

According to a ninth aspect of the disclosure there is provided a method of controlling the organoleptic properties of a foodstuff comprising applying to, and/or using in, the foodstuff a free-flowing edible composition as hereinbefore described. In each of these various aspects, the person of ordinary skill in the art will appreciate that the edible compositions need not remain free-flowing in such foodstuffs or beverages.

Another aspect of the disclosure relates to the use of a composition as described herein as a delivery vehicle to provide an organoleptic property of the second edible material having a desired time profile. As described throughout the present specification, the person of ordinary skill in the art can adjust the various particle sizes and distributions of the components of the compositions to provide a desired time profile of an organoleptic property of the second edible material. This organoleptic property can be, for example, taste, as would be the case with salt or a sweetener. Of course, in other embodiments, the organoleptic property is some other sensation, e.g., smell or colour.

According to a tenth aspect, the disclosure provides a method of preparing a free-flowing, edible composition as described herein, said method including:
(a) combining the first edible material, provided in dry particulate form, with the second edible material, provided in dry particulate form; and
(b) heating said combination to a forming temperature (T_{f}), which is at least equal to the glass transition temperature or softening temperature of the first edible material, with concurrent mixing thereof, so as to coat particles of the first edible material with a first plurality of non-uniformly sized particles of the second edible material, thereby forming composite particles of said composition, and leaving a second plurality of non-uniformly sized particles of the second edible material remaining which are intermingled with said composite particles.

The method according to the tenth aspect of the disclosure can advantageously be performed as a “dry” method, i.e. no solvent is explicitly added to the combination of first and second edible materials during step (a) and/or step (b). Each of the first and second edible materials is thus “dry” in this sense, but as the person of ordinary skill in the art will appreciate, each may include a relatively low percentage by weight of adsorbed water, typically less than 10% by weight, or in some cases less than 5% or less than 2%, yet still be considered as “dry” for the purposes of the present disclosure due to lack of explicitly added solvent. The benefits of operating a dry preparation method are numerous, including a reduction in the operational and capital costs as compared to known “wet” methods, and an increase in the operational lifetime of the equipment needed to perform the method, particularly given that the prior art problem of corrosion is mitigated with a dry process.

The methods described herein can produce a free-flowing composition, having controllable properties of bulk density, particle morphology (in relation to both the morphology of the composite particles and the morphology of the particles of second edible material), flowability and shakeability (which will be defined below), in the form of a blend of composite particles and a plurality of non-uniformly sized particles of second edible material. Caking and agglomeration of the blend can be minimised if not completely eliminated. Accordingly, in certain advantageous embodiments, the methods and compositions described herein do not require the addition or use of further ingredients to achieve the desired flowability of the composition. Thus, in certain embodiments of the compositions described herein, the compositions can be substantially free of anticaking agents such as silicon dioxide, tricalcium phosphate, powdered cellulose, magnesium stearate, sodium bicarbonate, sodium ferrocyanide, potassium ferrocyanide, bone phosphate, sodium silicate, calcium silicate, magnesium trisilicate, talcum powder, sodium aluminosilicate, potassium aluminium silicate, calcium aluminosilicate, bentonite, aluminium silicate, stearic acid and polydimethylsiloxane. Furthermore, the methods described herein can produce a free-flowing composition for which prior art problems of dusting are also mitigated.

With concurrent mixing of the combined first and second edible materials, a discontinuous coating, having a rough surface morphology, composed of discrete, non-uniformly sized particles of the second edible material can be formed, for example, over substantially the entire available surfaces of the cores of the composite particles. Such a rough surface is beneficial because it increases the available surface area of second edible material (as compared to a continuous surface for the same-sized particle of first edible material), which aids availability, e.g. dissolution, thereof. Because the coating is discontinuous, it may be formed over less than 100% of the available surface area of the cores, however, it is preferred that coverage is maximised to 100% in so far as is possible given any limitation on the duration of the overall method.

The first and second edible materials may be provided in step (a) in a variety of ratios. In certain embodiments, the ratio of the first edible material to the second edible material is substantially the same as in the free-flowing edible composition (i.e., any of the ratios described above). In other embodiments, the ratio of the first edible material to the second edible material provided in step (a) of the method is somewhat different than in the overall free-flowing edible composition; additional second edible material can be added after the performance of step (b) of the method. The additional second edible material can have the same particle size distribution or a different particle size distribution than the second edible material added in step (a). The person of ordinary skill in the art can determine what particle size distributions should be used in order to provide desired physical and organoleptic properties to the composition. In any case, provision of an excess of the second edible material as compared to the first edible material is advantageous in ensuring that the requisite blend is achieved via the method of the disclosure, in particular, the existence of both the first and second pluralities of non-uniformly sized particles of second edible material.

To achieve the aforementioned preferred distribution of particle sizes of the second edible material, in step (a), the second edible material may be provided in a pre-prepared range of non-uniform particles sizes, and/or the act of combining particles of the first edible material with particles of the second edible material in step (a) and/or the act of mixing the first edible material with the second edible material in step (b) may lead to attrition of the particles of second edible material so as to achieve the desired distribution.

In respect of the composite particles of the blend, the first edible material is the material on which the plurality of particles of second edible material is disposed, and thus the glass transition temperature or softening temperature of the first edible material can in certain advantageous embodiments be lower than the glass transition temperature or softening temperature of the second edible material, as described above. In this way, only the first edible material may soften to enable embedding of the particles of the second edible material therein. Accordingly, the forming temperature may preferably be lower than the glass transition temperature or softening temperature of the second edible material.

As discussed earlier in this specification, the glass transition temperature (T_{g1}) of the first edible material can be, for example, in the range of from about 10° C. to about 120° C., preferably from about 20° C. to about 110° C. and most preferably from about 30° C. to about 90° C. The forming temperature (T_{f}) is at least equal to the glass transition temperature or softening temperature of the first edible material. For example, T_{f} can be at least about 10° C., or about 15° C. higher than the glass transition temperature or softening temperature of the first edible material. In certain such embodiments, T_{f} is up to around 50° C. or even up to around 35° C. higher than the glass transition temperature or softening temperature of the first edible material. For example, T_{f} can be in the range of about 10-50° C., or 10-35° C. higher than the glass transition temperature or softening temperature of the first edible material, and in some embodiments in the range of about 15-25° C. higher. Ultimately, the aim is to provide the particles of first edible material in a form such that a first plurality of particles of the second edible material is able to “stick” (e.g., embed) into their outer surface to form the desired composite particles. Furthermore, the higher the forming temperature, the shorter the processing time generally needed, and thus the lower the cost of performance of the method. But the forming temperature is desirably not so high that the first edible material melts or becomes so soft as to lose its essentially particulate character. A person skilled in the art, faced with the aim of providing a particular combination of first and second edible materials, would be able to judge the forming temperature (T_{f}) based on the glass transition temperatures of the materials in question in view of the present disclosure.

In certain advantageous embodiments, the glass transition temperature or softening temperature of the second edible material is at least 20° C., at least 30° C., or at least 50° C., or even at least 100° C. greater than T_{f}.

In step (b) of the method, the combination of first and second edible materials can be maintained at the forming temperature (T_{f}) for a period of time sufficient to provide the particles of the second edible material on the core of the first edible material as described herein. For example, in certain embodiments, the forming time is in the range of from about 10 to 40 minutes, preferably in the range of from about 20 to 30 minutes, but preferably no longer than about 1 hour, so as to ensure that energy costs savings are not lost and to avoid any possible adverse side reactions that may occur. Of course, a person skilled in the art will appreciate that the processing time will ultimately depend on the equipment used to perform the method, as well as the processing conditions employed.

Further preferably, in certain embodiments the combination may be continuously mixed whilst being maintained at the forming temperature (T_{f}).

In one embodiment of the disclosure, in step (a), the first edible material may be combined with the second edible material to form a mixture of desired distribution prior to performance of step (b). Such a mixture may lead to a substantially uniform mutual distribution of the two materials. In this embodiment, the mixture is formed prior to subjecting it to the heating of step (b). Thereafter, in step (b), the mixture is heated to the forming temperature (T_{f}), at which it may remain for a period sufficient to provide the particles of the second edible material on the core of the first edible material as described herein, e.g., in the range of 5 to 20 minutes. Separation of steps (a) and (b) into two distinct steps means that the method may be operated as a batch method, in which a quantity of edible composition is prepared in appropriate mixing and heating equipment and subsequently removed prior to a second quantity being identically prepared, or as a continuous method in which a constant stream of edible composition is prepared by feeding first and second edible materials through appropriate mixing and heating equipment on a continuous basis. For both batch operation and continuous operation, the heating vessel used for step (b) may be kept at or around the forming temperature because the first and second edible materials are pre-mixed (in step (a)) prior to their introduction thereto.

In an alternative embodiment of the disclosure, steps (a) and (b) may be performed substantially, if not entirely, simultaneously, such that the first edible material may be combined with the second edible material to form a mixture of desired mutual distribution whilst said materials are heated to the forming temperature (T_{f}). By ensuring that the materials are brought to the desired mixture whilst being heated, the same quality of edible composition as may be achieved via the alternative embodiment described above may be obtained, however, this one-step method may only be suitable for batch operation as the heating vessel would need to be cooled (to prevent overly rapid heating of the materials) between batches.

Combination of the first and second edible materials in step (a), and heating of the combination of first and second edible materials in step (b), of the method of the disclosure can be performed in any suitable device having both material agitation and heating capability, particularly heat-capable low-shear mixing devices, such as dry blenders, blending/propelling augers, horizontal reactors, tumblers, and the like.

If, as described earlier in this specification, an at least third edible material is present in the core of the composite particles along with the first edible material, said at least third edible material may be admixed with the first edible material prior to step (a) of the method to form a mixed edible core material in dry particulate form, which is subsequently combined with the second edible material in step (a), prior to said combination being heated in step (b). In other words, the composite particles formed would have a core that is a mixture of the first and at least third edible materials, said core being coated with particles of the second edible material.

If, as described earlier in this specification, the second edible material is formed from two or more components, a mixture of at least some of said components may be provided prior to step (a) of the method, such that the first edible material in dry particulate form is subsequently combined with the component mixture of second edible materials in step (a), prior to said combination being heated in step (b). In other words, the composite particles formed would have a core of the first edible material, said core being coated with particles of the mixture of at least some components of second edible material.

Of course, each of the aforementioned two possibilities may be combined, such that the composite particles comprise first and at least third edible materials in their cores, said cores being coated with a mixture of at least some of the two or more components forming the second edible material.

Additional information relevant for the formation of composite particles can further be found in International Patent Application no. PCT/GB2014/052576 (published as WO2015/028784A1), which is hereby incorporated herein by reference in its entirety.

For a better understanding, various aspects of the disclosure will now be more particularly described, by way of non-limiting example only, with reference to the accompanying drawings.

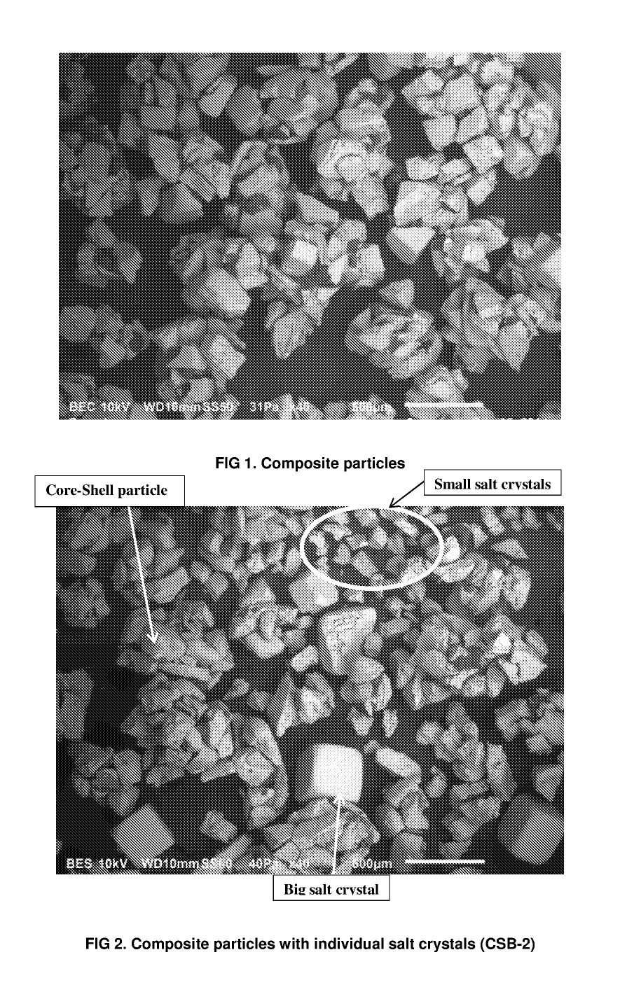

Composite particles were formed as described herein, using a particulate salt having a non-uniform particle size, with particle sizes ranging from a few tens of microns to several hundred microns (see FIG. 5). The composite particle comprises a core of a soluble corn fiber, e.g. Promitor™ Soluble Corn Fiber 70, (first edible material) provided with a discontinuous surface coating formed from a first plurality of non-uniformly sized particles of salt (second edible material). An SEM image of the composite particles is shown in FIG. 1. The plurality of composite particles contains, on average, 90 wt % of salt and has a bulk density of 0.66 g/cm³.

FIG. 2 is an SEM of a free-flowing edible composition comprising a blend of (i) a plurality of composite particles such as is shown in FIG. 1, and (ii) a second plurality of non-uniformly sized particles of salt (second edible material). The blend contains, on average, 95 wt % of salt and has a bulk density of 0.81 g/cm³. This composition was made by forming composite particles with a fraction of the ground salt starting material, then adding the rest of the ground salt starting material to form the blended composition. Two such compositions were made—“CSB-1” and “CSB-2”—which are detailed in Table 1 below:

TABLE 1

| | CSB-1 | CSB-2 |
|---|---|---|
| Composite Particles (wt %) | 65.5 | 70 |
| Additional Salt to Form | 34.5 | 30 |
| Blend (wt %) | | |
| Total Salt in Blend (wt %) | 95.9 | 95.6 |
| Bulk Density (g/cc) | 0.81 | 0.81 |

In order to make an edible composition such as is shown in FIG. 2, the following typical method of production may be performed in a heated dry blender:
(1) combine a first edible material, provided in dry particulate form, and a second edible material, provided in dry particulate form, by adding each separately or simultaneously into the blender;
(2) transfer the blender into a non-heated roller oven;
(3) turn on the roller to mix and blend the first and second edible materials for a period sufficient to ensure a blended mixture of desired distribution is formed;
(4) heat the oven to at least the forming temperature (T_{f}) of the first edible material and maintain for a period sufficient to ensure that particles of the first edible material are coated with a first plurality of non-uniformly sized particles of the second edible material forming the desired composite particles, and leaving a second plurality of non-uniformly sized particles of the second edible material remaining which are intermingled with said composite particles forming the blend;
(5) turn off the roller and remove the blender from the oven;
(6) optionally cool the blender and the resultant blend; and
(7) discharge the resultant free-flowing edible composition from the blender.

Such a method is a batch method and would require cooling of the blender (at least after the resultant composition has been discharged) prior to re-filling with a further quantity of first and second edible materials.

Alternatively, the method steps can be followed, suitably adapted, for performance as a continuous method in a continuous heated mixer.

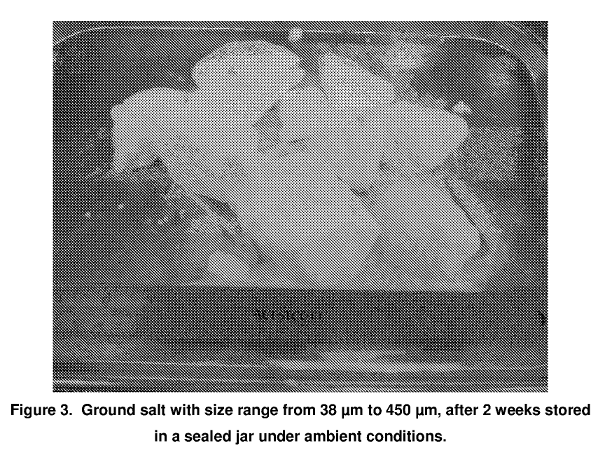

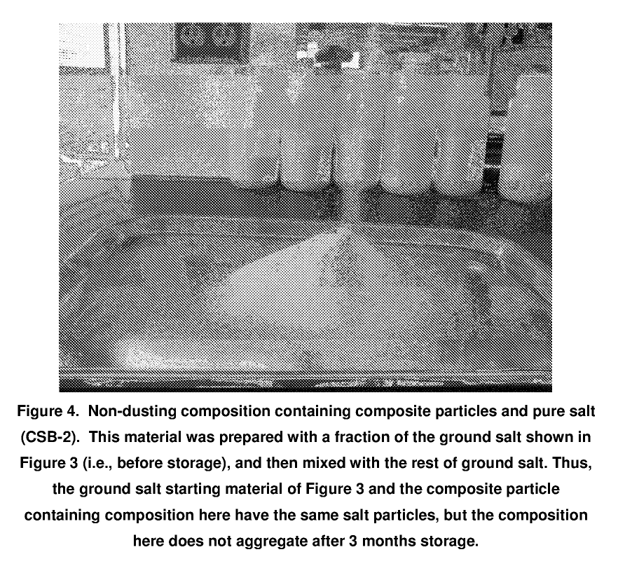

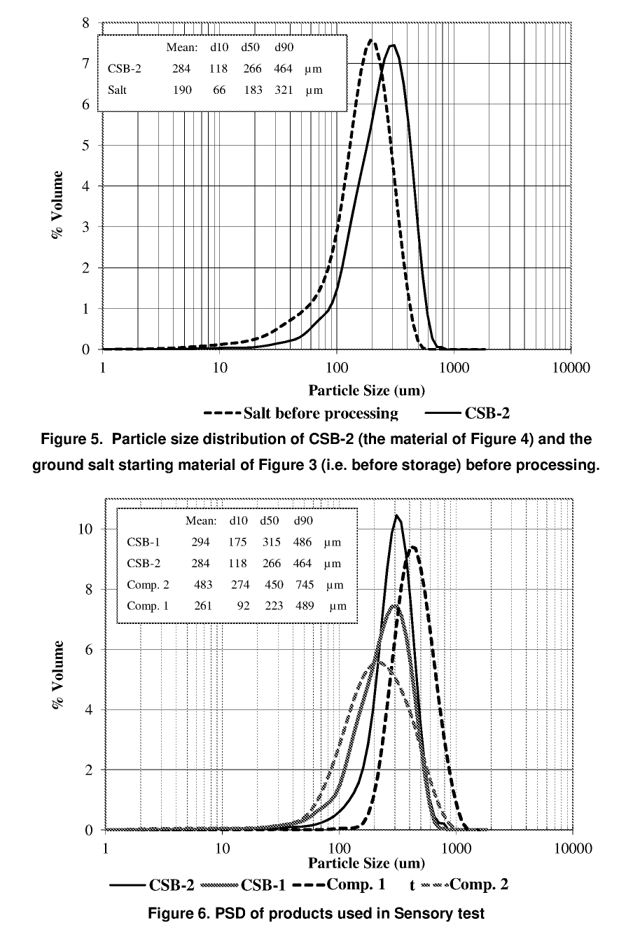

FIG. 3 is a picture of a sample of the salt material used to make the composite particles, after two weeks storage in a sealed jar under ambient conditions. After only two weeks the salt particles had agglomerated into much larger chunks of salt, and had lost its free-flowing character.

FIG. 4 is a picture of the free-flowing edible material of FIG. 2 after being stored in a sealed jar under ambient conditions for three months. In contrast to the unprocessed salt material, the composition including the composite particles retains free-flowing character even after three months storage.

FIG. 5 is a plot of a particle size distribution of the salt material used to make the composite particles and the particle size distribution of the free-flowing edible composition of FIG. 2.

### Sensory Testing

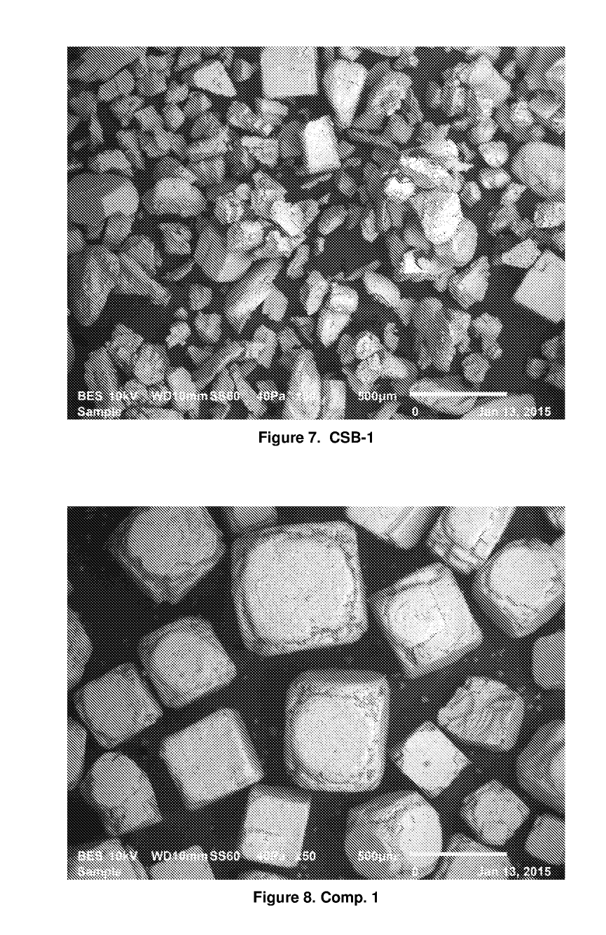

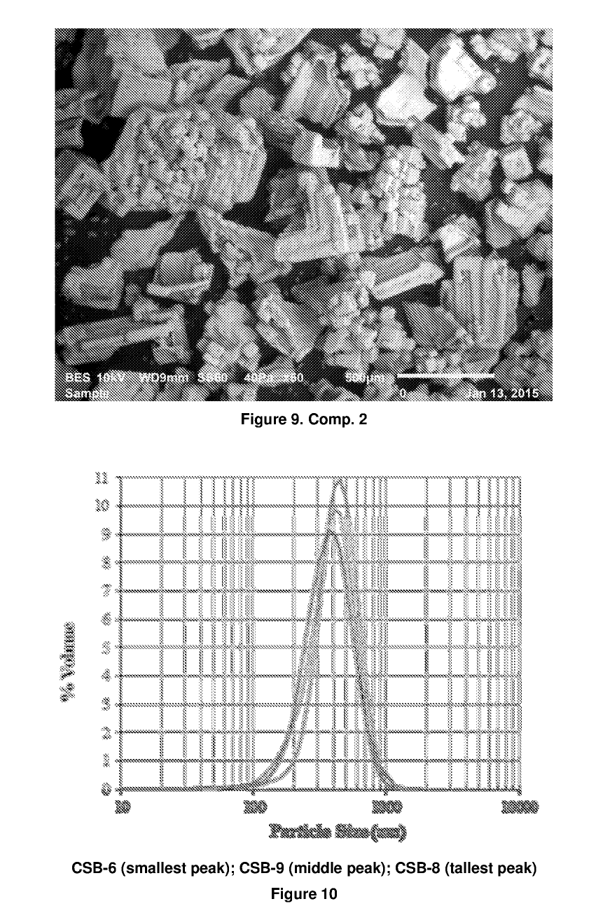

To test the efficacy of a free-flowing edible composition according to the first aspect of the disclosure containing second edible material, in this case salt, vis-à-vis conventionally available forms of salt, four products were tested on (used to season) French fries. Two of the products were commercial products (Comp. 1 and Comp. 2, respectively) whilst the other two products were compositions in accordance with the disclosure (CSB-1 and CSB-2). Particle size analyses of all four products are provided in FIG. 6, and an SEM of the CSB-1 composition is provided as FIG. 7.

### Preparation of the Seasoned French Fries

Potato was sliced to approximately ½ inch (1.27 cm) cross-section with a French fry slicer and fried. Batches of the resultant French fries were seasoned with each of the four products being tested in a mixing bowl with the salt sample in an amount of half a teaspoon of salt per 500 g of fries.

### Sensory Results

Affective testing using “The 9-Point Hedonic Scale” and “Just-About-Right” (JAR) scales was conducted with 60 panellists. The 9-Point Hedonic Scale is used to rate the liking of products, and runs from “Dislike Extremely” to “Like Extremely”. This is a commonly used scale. JAR questions were used to score the test samples. JAR questions use Likert scales (e.g. not nearly salty enough, not salty enough, Just-About-Right, too salty, much too salty). The two lower scores were combined for the “not enough” category, the three lower scores were combined for the “Just-About-Right” category, and the two higher scores were combined for the “too much” category to give JAR scores. The measure is the percentage of panellists.

The products were randomized and presented in a sequential monadic design. The French fries were served in 5 ounce soufflé cups to give the panellists ample product for testing. The panellists were instructed to consume enough of the sample to answer each question. Cups were labelled with 3-digit blinding codes. There was a two minute enforced waiting period between samples to clear the panellists' palates. Reverse osmosis (‘RO’) water and unsalted crackers were available for the panellists to clear their palates before and during testing.

Table 2 below shows that CSB-1 and CSB-2 were rated significantly higher for overall acceptance than either of Comp. 1 or Comp. 2. Furthermore, CSB-2 was rated significantly higher in flavour acceptance than Comp. 1 or Comp. 2. CSB-2 and CSB-1 were not significantly different from one another in flavour acceptance.

CSB-1 was rated significantly higher in flavour acceptance than Comp. 1 but not significantly different from Comp. 2 in flavour acceptance.

Significance testing used “Friedman's Rank Sum Test”. Friedman's Test is a non-parametric test for ranked data. It is the nonparametric equivalent of a two-way Analysis of Variance (‘ANOVA’). Samples that share the same letter are not statistically different from each other by the Wilcoxon, Nemenyi, McDonald-Thompson post-hoc test.

Acceptance scores by product were blocked by panellist.

TABLE 2
Acceptance Rating-Rank Sums

| | Overall | Appearance | Aroma | Flavour | Texture |
|---|---|---|---|---|---|
| CSB-2 | 182.5^{a} | 158.5^{a} | 166.5^{ab} | 181.0^{a} | 169.5^{a} |
| CSB-1 | 176.0^{a} | 163.0^{a} | 172.0^{a} | 170.5^{ab} | 143.5^{b} |
| Comp. 2 | 142.0^{b} | 159.5^{a} | 143.0^{b} | 148.5^{b} | 159.0^{ab} |
| Comp. 1 | 99.5^{c} | 119.0^{b} | 118.5^{b} | 100.0^{c} | 128.0^{c} |

The “Wilcoxon, Nemenyi, McDonald-Thompson Pairwise Comparison Test” was used as the post-hoc test when Friedman's Test was significantly different at an alpha of 0.05. A post-hoc test determines which samples are statistically significantly different. The Wilcoxon, Nemenyi, McDonald-Thompson critical value is 25.7 at an alpha of 0.05. Rank sum differences larger than the critical value are significantly different.

Table 3 below shows that 67% of the panellists thought that the saltiness of French fries seasoned with CSB-1 and CSB-2 was “Just-About-Right” (JAR). 85% of the panellists thought that the French fries seasoned with Comp. 1 were not salty enough, whilst 58% of the panellists thought that French fries seasoned with Comp. 2 were not salty enough.

TABLE 3
Saltiness JAR

| | % Not Salty | | | % Too | |
|---|---|---|---|---|---|
| Product | Enough | Mean Drop | % JAR | Salty | Mean Drop |
| CSB-1 | 27 | −1.6 | 67 | 7 | −1.3 |
| CSB-2 | 20 | −1.1 | 67 | 13 | −1.2 |
| Comp. 1 | 85 | −0.3 | 13 | 2 | −2.8 |
| Comp. 2 | 58 | −1.1 | 38 | 3 | −3.5 |

### Shakeability Testing

To test the “shakeability” from a typical tabletop salt shaker of a free-flowing edible composition according to the first aspect of the disclosure (containing second edible material, in this case salt) vis-à-vis a conventionally available form of salt and a competitor “reduced salt” product, five products were tested. Two of the products were commercial products, “Comp. 3” (conventional salt) and “Comp. 4” (“reduced salt” product), whilst the other three products were compositions in accordance with the invention, “CSB-6”, “CSB-8” and “CSB-9”. The compositions of the latter are shown below in Table 4.

TABLE 4

| | | | Composite | Total Salt in |
|---|---|---|---|---|
| | 1^{st} Edible | 2^{nd} Edible | Particles | Blend |
| Product | Material | Material | (wt %) | (wt %) |
| CSB-6 | Dry Corn | Salt | 10.5 | 89.5 |
| | Syrup | | | |
| CSB-8 | Maltosweet ™ | Salt | 8.3 | 91.7 |
| | (maltodextrin) | | | |
| CSB-9 | SCF | Salt | 10.5 | 89.5 |

The “shakeability” methodology was as follows: all products were filled into the same type of tabletop salt shaker. Each salt shaker had nine openings of 2.5 mm diameter in the top surface of its respective cap for the salt to fall through once the shaker was inverted. All the shakers were filled to the same level. Samples were dispensed by:
(1) inverting a shaker
(2) shaking ten shakes of the product from the shaker into a weighing dish
(3) weighing the dispensed product.

This methodology was repeated for each of the five shakers.

Furthermore, the test was repeated in triplicate; the results were averaged to determine the typical amount of product dispensed in ten shakes, for each of the five shakers. A significant level of sodium reduction with the three products in accordance with the invention was demonstrated through this test, as shown in Table 5 below.

TABLE 5
Shakeability Test Results

| | Loose Bulk | Particle | Avg. Amount | |
|---|---|---|---|---|
| | Density | Size | Dispensed | % |
| Product | (g/cc) | (μm) | (g) | Reduction |
| Comp. 3 | 1.15 | 470 | 0.73 | — |
| Comp. 4 | 0.75 | 276 | 018 | 76 |
| CSB-6 | 0.99 | 410 | 0.44 | 39 |
| CSB-8 | 1.00 | 460 | 0.39 | 47 |
| CSB-9 | 0.99 | 420 | 0.35 | 53 |

Comp. 4 (the competitor “reduced salt” product) was shown to not flow well from a salt shaker on account of its much smaller particle size and overly reduced loose bulk density (as compared to Comp. 3) as it resulted in excessive sodium reduction (76%). Each of the products according to the invention—CSB-6, CSB-8 and CSB-9—flowed much better on account of their desirable particle sizes and loose bulk densities and resulted in more reasonable sodium reductions (39-53%). It was also shown that the characteristics of the core-shell product can be altered to achieve a certain desired sodium reduction when dispensed from a typical salt shaker.

The results also demonstrated that, other than the density and particle size, there are other factors that influence the amount of product that is dispensed. The flowability of the samples significantly influences the amount of product dispensed from a shaker.

Each of the products according to the invention (CSB-6, CSB-8 and CSB-9) is able to achieve significant sodium reduction through the combination of the following:
composition—the presence of an edible material other than salt (in the examples above, carbohydrate) in the core reduces the amount of total salt by weight in the composition
loose bulk density—the lower loose bulk density of these products can be tailored to achieve a desired sodium reduction by volume so that, spoon-for-spoon, significantly less sodium is used
shakeability—the flow properties of the products according to the invention can be tailored to achieve a desired sodium reduction by weight when dispensed from a standard salt shaker.

In accordance with the teaching herein, a free-flowing edible composition can be prepared so as to combine these three factors in different ways to obtain the desired product with a tailor-made particle size and sodium reduction capability taking into account how it will be used, such as dispensing from a salt shaker.

1. A free-flowing edible composition having controllable properties of bulk density, particle morphology, flowability and shakeability, said composition comprising a blend of:
(i) a plurality of substantially discrete composite particles, each composite particle comprising a core of a first edible material provided with a discontinuous surface coating formed from a first plurality of non-uniformly sized particles of a second edible material; and
(ii) a second plurality of non-uniformly sized particles of said second edible material.

2. A free-flowing edible composition as claimed in claim 1 wherein at least about 85% of the non-uniformly sized particles of the second edible material (i.e., of the first and second pluralities of particles considered together) have a particle size in the range of from about 5 μm to about 2000 μm, or in the range of from about 10 μm to about 1000 μm, whereby one or more of the controllable properties of the composition is variable.

3. A free-flowing edible composition as claimed in claim 1 wherein the average particle size of the second edible material is in the range of from about 5 μm to about 2000 μm, whereby one or more of the controllable properties of the composition is variable.

4. A free-flowing edible composition as claimed in claim 1, wherein the D₁₀ of the particles of the second edible material is at least about 10 μm, whereby one or more of the controllable properties of the composition is variable.

5. A free-flowing edible composition as claimed in claim 1, wherein the D₁₀ of the particles of the second edible material is in the range of about 5 μm to about 200 μm, or about 10 μm to about 150 μm, or about 25 μm to about 100 μm, or about 5 μm to about 200 μm, or about 5 μm to about 100 μm, or about 10 μm to about 200 μm, or about 10 μm to about 150 μm, or about 25 μm to about 200 μm, or about 25 μm to about 150 μm, whereby one or more of the controllable properties of the composition is variable.

6. A free-flowing edible composition as claimed in claim 1, wherein the D₉₀ of the particles of the second edible material is in the range of about 150 μm to about 2000 μm, whereby one or more of the controllable properties of the composition is variable.

7. A free-flowing edible composition as claimed in claim 1, wherein at least about 85% of the composite particles in the plurality thereof have a particle size in the range of from about 35 μm to about 2000 μm, whereby one or more of the controllable properties of the composition is variable.

8. (canceled)

9. A free-flowing edible composition as claimed in claim 1, wherein the composite particles have a mass of the core of in the range of about 5% to about 45 as compared to the mass of the overall composite particles, whereby one or more of the controllable properties of the composition is variable.

10. A free-flowing edible composition as claimed in claim 1, wherein at least about 50% of the composition is made up of the composite particles and the second plurality of the non-uniformly sized particles, whereby one or more of the controllable properties of the composition is variable.

11. A free-flowing edible composition as claimed in claim 1, wherein the second edible material is present in an amount of at least about 65 wt % of the overall composition, whereby one or more of the controllable properties of the composition is variable.

12. A free-flowing edible composition as claimed in claim 1, wherein the first and second edible materials are present in a ratio (by mass) of at least about 1:3, at least about 1:4, at least about 1:5, at least about 1:7, at least about 1:9, at least about 1:19, at least about 1:29, at least about 1:39, at least about 1:49, or at least about 1:98, or in the range of from about 1:3 to about 1:9, or about 1:3 to about 1:14, about 1:3 to about 1:19, or about 1:3 to about 1:29, or about 1:3 to about 1:39, or about 1:3 to about 1:49, or about 1:3 to about 1:98, or about 1:3 to about 1:99, or about 1:3 to about 1:199, or about 1:4 to about 1:9, or about 1:4 to about 1:14, about 1:4 to about 1:19, or about 1:4 to about 1:29, or about 1:4 to about 1:39, or about 1:4 to about 1:49, or about 1:4 to about 1:98, or about 1:4 to about 1:99, or about 1:4 to about 1:199, or about 1:5 to about 1:9, or about 1:5 to about 1:14, about 1:5 to about 1:19, or about 1:5 to about 1:29, or about 1:5 to about 1:39, or about 1:5 to about 1:49, or about 1:5 to about 1:98, or about 1:5 to about 1:99, or about 1:5 to about 1:199, or about 1:7 to about 1:9, or about 1:7 to about 1:14, about 1:7 to about 1:19, or about 1:7 to about 1:29, or about 1:7 to about 1:39, or about 1:7 to about 1:49, or about 1:7 to about 1:98, or about 1:7 to about 1:99, or about 1:7 to about 1:199, or about 1:9 to about 1:14, about 1:9 to about 1:19, or about 1:9 to about 1:29, or about 1:9 to about 1:39, or about 1:9 to about 1:49, or about 1:9 to about 1:98, or about 1:9 to about 1:99, or about 1:9 to about 1:199, whereby one or more of the controllable properties of the composition is variable.

13. A free-flowing edible composition as claimed in claim 1, wherein the ratio (by mass) of the composite particles to the second plurality of particles is in the range of about 15:85 to about 75:25, whereby one or more of the controllable properties of the composition is variable.

14. A free-flowing edible composition as claimed in claim 1, having a bulk density of at least about 0.6 g/cm³.

15. A free-flowing edible composition as claimed in claim 1, wherein the cores of the composite particles have an average surface coverage in the range of at least about 70%, whereby one or more of the controllable properties of the composition is variable.

16. (canceled)

17. A free-flowing edible composition as claimed in claim 1, wherein the glass transition temperature or softening point of the first edible material is at least about 20° C., than the glass transition temperature of the second edible material.

18. A free-flowing edible composition as claimed in claim 1, wherein the glass transition temperature or softening point of the first edible material is in the range of from about 10° C. to about 120° C.

19. (canceled)

20. A free-flowing edible composition as claimed in claim 1 wherein each composite particle further comprises at least a third edible material, which is mixed with the first edible material in the core, around which the discontinuous surface coating is provided, whereby one or more of the controllable properties of the composition is variable.

21-22. (canceled)

23. A free-flowing edible composition as claimed in claim 1 wherein the first edible material is a natural or synthetic edible carrier material comprising any one or more of the following:
monosaccharides, e.g. glucose, fructose, galactose, xylose;
disaccharides, e.g. sucrose, lactose, maltose;
polysaccharides, e.g. starch, maltodextrin, cellulose, soluble corn fiber, oat-derived polysaccharides;
and derivatives thereof, whereby one or more of the controllable properties of the composition is variable.

24. A free-flowing edible composition as claimed in claim 1 wherein the second edible material is a natural or synthetic flavouring, colorant and/or preservative, comprising any one or more of the following:
Salt, e.g., sodium chloride, potassium chloride, or a mixture thereof;
Garlic, onion;
taste enhancers, e.g. high potency sweeteners, yeast extract, monosodium glutamate;
culinary herbs and spices, e.g. cinnamon, saffron, black, white or green pepper;
monosaccharides, e.g. glucose, fructose, galactose, xylose;
disaccharides, e.g. sucrose (e.g. refined sugar), lactose, maltose;
oligosaccharides, e.g. maltodextrin;
and derivatives thereof, whereby one or more of the controllable properties of the composition is variable.

25. A free-flowing edible composition as claimed in claim 1 comprising any of the following first edible material/second edible material combinations:
crystalline fructose/cinnamon;
mixture of soluble corn fiber and maltodextrin/mixture of salt and pepper;
soluble corn fiber/salt;
soluble corn fiber/salt derivative;
sucrose/allulose, whereby one or more of the controllable properties of the composition is variable.

26. A free-flowing edible composition as claimed in claim 1 wherein the first edible material is a polysaccharide and the second edible material is salt, whereby one or more of the controllable properties of the composition is variable.

27-28. (canceled)

29. A foodstuff or a beverage seasoned, coloured and/or preserved with a free-flowing edible composition as claimed in claim 1.

30-31. (canceled)

32. A foodstuff according to claim 29, wherein the foodstuff is snack chips such as potato and corn chips, salted nuts such as peanuts, pretzels, bagels, salted confectionary, cookies, crackers, breads, cakes, nutrition bars or fried potatoes.

33. A method of seasoning, colouring and/or preserving a foodstuff or a beverage comprising applying to, or incorporating in, the foodstuff or the beverage a free-flowing edible composition as claimed in claim 1.

34. A method of producing a foodstuff or a beverage comprising preparing a precursor of the foodstuff or beverage, incorporating the free-flowing edible composition as claimed in claim 1, and cooking the precursor to produce the foodstuff or the beverage.

35. A method of topically seasoning a foodstuff comprising applying to the foodstuff a free-flowing edible composition as claimed in as claimed in claim 1.

36. A method of tenderising, curing, plumping or seasoning meats with a free-flowing edible composition, wherein said composition is provided by a free-flowing edible composition as claimed in as claimed in claim 1.

37. A method of canning or pickling a foodstuff using a free-flowing edible composition, wherein said composition is provided by a free-flowing edible composition as claimed in as claimed in claim 1.

38. A method of reducing the amount consumed per unit measure of a foodstuff or beverage ingredient, such as a seasoning, colouring and/or preserving agent, used on or in a foodstuff or beverage to be consumed, said method comprising replacing a unit measure of the ingredient with a unit measure of a free-flowing composition as claimed in claim 1 which comprises said ingredient as the second edible material thereof.

39. A method of controlling the organoleptic properties of a foodstuff comprising applying to, and/or using in, the foodstuff a free-flowing edible composition as claimed in claim 1.

40. (canceled)

41. A method of preparing a free-flowing, edible composition having controllable properties of bulk density, particle morphology, flowability and shakeability according to claim 1, said method comprising the steps of:
(a) combining the first edible material, provided in dry particulate form, with the second edible material, provided in dry particulate form; and
(b) heating said combination to a forming temperature (T_{f}), which is at least equal to the glass transition temperature or softening temperature of the first edible material, with concurrent mixing thereof, so as to coat particles of the first edible material with a first plurality of non-uniformly sized particles of the second edible material, thereby forming composite particles of said composition, and leaving a second plurality of non-uniformly sized particles of the second edible material remaining which are intermingled with said composite particles.

42-46. (canceled)

47. A method as claimed in claim 41 wherein the forming temperature is at least about 10° C. higher than the glass transition temperature or softening point of the first edible material.

48. A method as claimed in claim 41, wherein the glass transition temperature or softening temperature of the second edible material is at least 20° C. greater than the forming temperature.

49-50. (canceled)
